(19) United States
(12) Patent Application Publication
(10) Pub. No.: US 2010/0149940 A1
(43) Pub. Date: Jun. 17, 2010

(54) CLOCK SIGNAL GENERATION DEVICE

(76) Inventors: Kohei Nakata, Nara (JP); Harumitsu Miyashita, Nara (JP); Takeshi Nakajima, Nara (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/067,902

(22) PCT Filed: Sep. 27, 2006
(86) PCT No.: PCT/JP2006/319175

§ 371 Date: Mar. 24, 2008

(30) Foreign Application Priority Data
Sep. 29, 2005 (JP) 2005-284332

(51) Int. Cl. G11B 20/18

(52) U.S. Cl. 369/53.34; G9B/20.046

(57) ABSTRACT

A clock signal generator according to the present invention includes: a wobble phase error detecting section for detecting a wobble phase error that is a difference in phase between a wobble signal, representing a wobbled shape of a track on an optical disk medium, and a clock signal; a data phase error detecting section for detecting a data phase error that is a difference in phase between a data signal, representing data that has been written on the optical disk medium, and the clock signal; a frequency control section for generating a frequency control signal to control the frequency of the clock signal based on the wobble phase error and the data phase error; and a clock oscillation section for generating the clock signal with its frequency controlled in accordance with the frequency control signal.

### TECHNICAL FIELD

The present invention relates to a clock signal generator for generating a clock signal based on a wobble signal representing the wobbled shape of a track on an optical disk medium and a data signal representing data that has been written on the optical disk medium.

### BACKGROUND ART

On a recordable optical disk medium, a track groove has been formed in advance and information is written along the track groove, i.e., either on the track groove or on an area (which is called a “land”) between adjacent portions of the track groove. Also, the track groove is formed so as to wobble in a sine wave pattern, and information is written there in response to a write clock signal that has been generated based on its wobbling period. Such a write clock signal that is synchronized with the wobble period is normally generated using a PLL (phase-locked loop) (see Patent Document No. 1, for example).

Furthermore, to write information at a predetermined location on a storage layer of an optical disk medium, an ADIP (address in pregroove) is sometimes arranged along the track groove. Examples of known methods for modulating addresses include a PSK (phase shift keying) modulation and an MSK (minimum shift keying) modulation (see Patent Document No. 2, for example).

On the other hand, to read information that has been written on the track, a read clock signal, which is synchronized with a read data signal, is generated with a PLL, and the data signal synchronized with this read clock signal is digitized, thereby decoding information based on the digital data thus obtained (see Patent Document No. 3, for example).

FIG. 30 is block diagram showing an optical disk drive 40 including a conventional clock signal generator.

An optical disk medium 100 has a wobbled track, on which information has been written. An optical head section 101 irradiates the optical disk medium 100 with a light beam, detects the intensity of the light that has been reflected from the optical disk medium 100, and outputs an electrical signal. An analog signal processing section 104 extracts a wobble signal, a data signal and a servo error signal from the electrical signal that has been supplied from the optical head section 101. A motor 102 rotates the optical disk medium 100. A servo circuit 103 controls a location on the track to be irradiated with the light beam by the optical head section 101 and the rotational frequency of the motor 102 based on the servo error signal. A clock signal generator 2120 generates a write clock signal and a read clock signal based on the wobble signal and the data signal, respectively.

An ADIP reading section 107 detects an ADIP that has been written by the PSK or MSK modulation method to read address information. A read/write access control section 108 controls, based on the address information that has been read, the timing to read and write data from/on the optical disk medium 100. A data modulating section 106 modulates write user data to be written on the optical disk medium 100. A power control section 105 controls the power of the light beam. Specifically, in writing, the power control section 105 controls the power of the light beam in accordance with the write data signal that has been modulated by the data modulating section 106. A data binarizing section 110 binarizes a digital data signal that has been generated by sampling the data signal in response to the read clock signal. A data demodulating section 111 demodulates the binarized data signal, thereby outputting read user data. A CPU 109 controls the read/write operations performed by the optical disk drive 40 by way of the read/write access control section 108.

Hereinafter, it will be described how the clock signal generator 2120 that generates a write clock signal and a read clock signal operates.

First, it will be described how the write clock signal is generated. An A/D converter 121 samples the wobble signal in response to the write clock signal, thereby outputting a digital wobble signal. A band-pass filter (BPF) 123 extracts wobble frequency components from the digital wobble signal to output a binarized wobble signal. A divide-by-n counter 124 divides the frequency of the write clock signal by n according to the wobble period. A phase error detecting section 125 detects a phase error between the count of the divide-by-n counter 124 and the binarized wobble signal. A charge pump 133 controls the output current based on the value of the phase error detected. A loop filter 134 smoothes the output current of the charge pump 133, thereby outputting a voltage signal. A voltage controlled oscillator (VCO) 135 generates a write clock signal at a frequency defined by the output voltage signal of the loop filter 134.

More specifically, the phase error detecting section 125 compares the timing of count done by the divide-by-n counter 124 to an associated edge of the binarized wobble signal. If the timing of count done by the divide-by-n counter 124 is lagging, the phase error detecting section 125 outputs an UP pulse signal with a width corresponding to the time lag. On the other hand, if the timing of count is leading, the phase error detecting section 125 outputs a DOWN pulse signal with a width corresponding to the time lead. In accordance with the UP pulse signal or the DOWN pulse signal received, the charge pump 133 pumps up or out current, thereby controlling the amount of current to be charged on the loop filter 134 and changing the voltages of the loop filter 134. The oscillation frequency of the VCO 135 is controlled based on the output voltage signal of the loop filter 134. The write clock signal that has been generated by the VCO 135 is fed back to the divide-by-n counter 124. These components operate in loops such that the difference in phase between the counting done by the divide-by-n counter 124 and the binarized wobble signal becomes as close to zero degrees as possible.

Next, it will be described how the read clock signal is generated. An A/D converter 127 samples the data signal in response to the read clock signal, thereby outputting a digital data signal. A phase error detecting section 129 detects a phase error between the data signal and the read clock signal based on the digital data signal. A loop filter 136 smoothes out the phase error value. A voltage controlled oscillator (VCO) 137 generates a read clock signal at a frequency defined by the output control voltage of the loop filter 136.

More specifically, the phase error detecting section 129 extracts, as a zero-cross position, a point with the smaller absolute value from the two points that interpose the zero-cross point of the digital data signal. If the position displaces on a leading edge, the phase error detecting section 129 uses that value as a phase error value as it is. On the other hand, if the position displaces on a trailing edge, the phase error detecting section 129 multiplies that value by −1 and outputs the product as the phase error value. The loop filter 136 includes a digital filter for smoothing the phase error value and a D/A converter for converting the output of the digital filter into a voltage signal. These components operate as a loop that controls the frequency of the read clock signal such that the phase error value becomes equal to zero.
Patent Document No. 1: Japanese Patent Application Laid-Open Publication No. 2000-113597
Patent Document No. 2: Japanese Patent Application Laid-Open Publication No. 2004-134009
Patent Document No. 3: Japanese Patent Application Laid-Open Publication No. 2000-100083

### DISCLOSURE OF INVENTION

### Problems to be Solved by the Invention

The conventional clock signal generator 2120, however, needs two VCOs, i.e., the VCO 135 for generating the write clock signal and the VCO 137 for generating the read clock signal. A VCO is an expensive analog component that dissipates a lot of power and yet the conventional clock signal generator needs two such analog components.

Also, the clock signal generator is usually integrated along with the data modulating section, the data demodulating section and the read/write access control section in a single LSI. In an LSI, however, a digital circuit operating responsive to the read clock signal and a digital circuit operating responsive to the write clock signal are asynchronous digital circuits that operate responsive to clock signals of two different systems. That is why such an LSI should have a very complicated configuration and a significantly increased circuit size.

In order to overcome the problems described above, the present invention has an object of providing a clock signal generator that can have the read clock signal and the write clock signal generated as a single clock signal by a VCO, that is inexpensive and dissipates much less power, and that can perform data read and write operations with good stability.

Another object of the present invention is to provide an inexpensive LSI with a simplified configuration by combining the two systems of read and write clock signals into a single system in the LSI.

### Means for Solving the Problems

A clock signal generator according to the present invention is designed to generate a clock signal. The generator includes: a wobble phase error detecting section for detecting a wobble phase error that is a difference in phase between a wobble signal, which is obtained from a wobbled shape of a track on an optical disk medium, and the clock signal; a data phase error detecting section for detecting a data phase error that is a difference in phase between a data signal, which is obtained from data that has been written on the optical disk medium, and the clock signal; a frequency control section for generating a frequency control signal to control the frequency of the clock signal based on the wobble phase error and the data phase error; and a clock oscillation section for generating the clock signal with its frequency controlled in accordance with the frequency control signal.

In one preferred embodiment, the frequency control section generates the frequency control signal based on the sum of the wobble and data phase errors, and changes the ratios of the wobble and data phase errors being added together according to the states of the wobble and data signals.

In this particular preferred embodiment, the frequency control section changes the ratios according to the qualities of the wobble and data signals.

In another preferred embodiment, if the wobble signal has an amplitude that is smaller than a first threshold value, the frequency control section sets the ratio of the wobble phase error to be lower than that of the data phase error. If the data signal has an amplitude that is smaller than a second threshold value, the frequency control section sets the ratio of the data phase error to be lower than that of the wobble phase error.

In still another preferred embodiment, a part of the wobbled shape of the track has been subjected to either a frequency modulation or a phase modulation. In an interval in which a wobble signal, which is obtained from the wobbled shape that has been subjected to the frequency modulation or the phase modulation, is detected, the frequency control section sets the ratio of the wobble phase error to be lower than that of the data phase error.

In yet another preferred embodiment, the frequency control section changes the ratios according to the degree to which at least one of the wobble and data signals is synchronized with the clock signal.

In yet another preferred embodiment, if the absolute value of the wobble phase error is greater than a first threshold value, the frequency control section sets the ratio of the wobble phase error to be higher than that of the data phase error. If the absolute value of the data phase error is greater than a second threshold value, the frequency control section sets the ratio of the data phase error to be higher than that of the wobble phase error.

In yet another preferred embodiment, unless phase locking is accomplished between the wobble signal and the clock signal, the frequency control section sets the ratio of the data phase error to be lower than that of the wobble phase error. Once phase locking has been accomplished, the frequency control section increases the ratio of the data phase error compared to the situation where the phase locking has not been accomplished yet.

In yet another preferred embodiment, a portion of the wobbled shape of the track has been subjected to either a frequency modulation or a phase modulation. If the detection rate of the wobbled shape that has been subjected to the frequency modulation or the phase modulation is lower than a predetermined threshold value, the frequency control section sets the ratio of the wobble phase error to be higher than that of the data phase error.

In yet another preferred embodiment, frame sync marks are arranged at regular intervals on the track of the optical disk medium. If the detection rate of the frame sync marks is lower than a predetermined threshold value, the frequency control section sets the ratio of the data phase error to be higher than that of the wobble phase error.

In yet another preferred embodiment, frame sync marks are arranged at regular intervals on the track of the optical disk medium. If the interval at which the frame sync marks are detected is longer or shorter than the predetermined interval, the frequency control section sets the ratio of the data phase error to be higher than that of the wobble phase error.

In yet another preferred embodiment, the frequency control section generates the frequency control signal based on the sum of the wobble and data phase errors and changes the ratios of the wobble phase error and the data signal to be added together according to a mode of operation of an optical disk drive including the clock signal generator.

In this particular preferred embodiment, in writing data on the optical disk medium, the frequency control section sets the ratio of the data phase error to be lower than that of the wobble phase error.

In another preferred embodiment, the clock oscillation section responds to the wobble and data phase errors more quickly in reading data from the optical disk medium than in writing data on the optical disk medium.

In still another preferred embodiment, in performing linking writing such that data to be written is synchronized with data that has already been written on the optical disk medium, the frequency control section sets the ratio of the data phase error to be higher than that of the wobble phase error until the data starts to be written but sets the ratio of the data phase error to be lower than that of the wobble phase error once the data has started to be written.

In yet another preferred embodiment, the track has a data area to write data on and a header area with address information associated with the data area. In reading the address information and the data from the header area and from the data area, respectively, the frequency control section sets the ratio of the wobble phase error to be lower than that of the data phase error. But in writing the data on the data area, the frequency control section sets the ratio of the data phase error to be lower than that of the wobble phase error.

In this particular preferred embodiment, the clock signal generator further includes a control section for detecting the frequency of the clock signal when accessing the header area, estimating, based on the frequency detected, the length of the data area that follows the header area, and locating the next header area.

In yet another preferred embodiment, the data phase error detecting section includes: a sampling section for sampling the data signal in response to the clock signal and outputting a digital data signal corresponding to the data signal; an interpolation filter section for interpolating the digital data signal, thereby outputting an interpolated digital signal; a digital data phase error detecting section for detecting the data phase error based on the interpolated digital signal; and a phase-locking control section for controlling a filter coefficient of the interpolation filter section based on the data phase error.

In yet another preferred embodiment, the wobble phase error detecting section includes: a first frequency divider section for dividing the frequency of the clock signal by M (where M is an integer that is equal to or greater than one), thereby outputting a first frequency-divided clock signal; a first sampling section for sampling the wobble signal in response to the first frequency-divided clock signal, thereby outputting a digital wobble signal corresponding to the wobble signal; and a digital wobble phase error detecting section for detecting the wobble phase error based on the digital wobble signal. The data phase error detecting section includes: a second frequency divider section for dividing the frequency of the clock signal by N (where N is an integer that is equal to or greater than one), thereby outputting a second frequency-divided clock signal; a second sampling section for sampling the data signal in response to the second frequency-divided clock signal, thereby outputting a digital data signal corresponding to the data signal; and a digital data phase error detecting section for detecting the data phase error based on the digital data signal.

An optical disk drive according to the present invention is characterized by including: a clock signal generator according to any of the preferred embodiments of the present invention described above; an optical head section for outputting a signal representing light that has been reflected from the optical disk medium; and an analog signal processing section for extracting the wobble signal and the data signal from the output signal of the optical head section and passing the wobble and data signals to the clock signal generator.

A method for generating a clock signal according to the present invention is characterized by including the steps of: detecting a wobble phase error that is a difference in phase between a wobble signal, which is obtained from a wobbled shape of a track on an optical disk medium, and the clock signal; detecting a data phase error that is a difference in phase between a data signal, which is obtained from data that has been written on the optical disk medium, and the clock signal; generating a frequency control signal to control the frequency of the clock signal based on the wobble phase error and the data phase error; and generating the clock signal with its frequency controlled in accordance with the frequency control signal.

In one preferred embodiment, the method of the present invention further includes the steps of: outputting signal representing light that has been reflected from the optical disk medium; and extracting the wobble signal and the data signal from the signal representing the reflected light.

A program according to the present invention is designed to get clock signal generation processing performed by a computer. The clock signal generation processing is characterized by including the steps of: detecting a wobble phase error that is a difference in phase between a wobble signal, which is obtained from a wobbled shape of a track on an optical disk medium, and a clock signal; detecting a data phase error that is a difference in phase between a data signal, which is obtained from data that has been written on the optical disk medium, and the clock signal; generating a frequency control signal to control the frequency of the clock signal based on the wobble phase error and the data phase error; and generating the clock signal with its frequency controlled in accordance with the frequency control signal.

### EFFECTS OF THE INVENTION

According to the present invention, the frequency of a clock signal generated by a single clock oscillation section (i.e., a VCO) is controlled based on both a wobble phase error and a data phase error. As a result, an inexpensive clock signal generator that would dissipate much less power is realized. Also, according to the present invention, it is determined, on the basis of the respective states of wobble and data signals, which of these two signals should be used preferentially to control the frequency of the clock signal. Consequently, data read and write operations can be performed with good stability.

In addition, the same clock signal can be used in common to trigger both data read circuitry and data write circuitry in an LSI, and therefore, the LSI can have a simplified circuit configuration. As a result, an inexpensive LSI is realized.

In the prior art, the clock signal for use to read data is generated based on only a data signal. That is why if the data signal discontinued due to the presence of a scratch or finger mark on an optical disk medium, then the frequency of the clock signal would lose stability and only a low degree of robustness could be realized in reading data. As used herein, the “robustness” refers to the ability of a system to maintain the current status even in spite of disturbance, design error and other fluctuations. In contrast, according to the present invention, the frequency of the clock signal is controlled using a wobble signal that is less likely to be affected by the presence of a finger mark or a scratch because its signal frequency range is lower than that of the data signal. For that reason, the frequency of the clock signal never loses its stability and the degree of robustness of data reading can be increased.

Furthermore, in the prior art, when additional data needs to be written to a DVD-R disk, the data that has already been written is read to determine where to start writing the additional data, and the data is written in response to a write clock signal generated based on the wobble signal, not the read clock signal. That is why the data that has already been written before the start point and the data that has been added after the start point should have two different phases, thus making it difficult to read data continuously and with stability before and after that point. Therefore, dummy data should be written there in the prior art. However, according to the present invention, the clock signal for reading the data that has already been written is the same as the clock signal for writing the additional data. For that reason, the phases of these two sets of data can be easily synchronized with each other before and after the point to start writing the additional data, no dummy data needs to be written anymore, and the remaining space on the disk can be used more effectively.

### BRIEF DESCRIPTION OF DRAWINGS

FIG. 1 is a block diagram showing an optical disk drive according to a preferred embodiment of the present invention.

FIG. 2 is a block diagram showing a clock signal generator according to a preferred embodiment of the present invention.

FIG. 3 shows a data format for an optical disk medium.

FIG. 4 is a timing diagram showing how to detect a wobble phase error in a preferred embodiment of the present invention.

FIG. 5 is a block diagram showing an interpolation filter according to a preferred embodiment of the present invention.

FIG. 6 shows a coefficient control curve for the interpolation filter of the preferred embodiment of the present invention.

FIG. 7 is a timing diagram showing how to detect a data phase error in a preferred embodiment of the present invention.

FIG. 8 is a block diagram showing a phase-locking control section according to a preferred embodiment of the present invention.

FIG. 9 is a timing diagram showing how the data phase-locked loop operates in a preferred embodiment of the present invention.

FIG. 10A is a block diagram showing a phase error adding section according to a preferred embodiment of the present invention.

FIG. 10B is a block diagram showing a phase error adding section according to a preferred embodiment of the present invention.

FIG. 11 is a table showing how to control the ratios of two types of phase errors to be added together in a preferred embodiment of the present invention.

FIG. 12 is a timing diagram showing how the phase error adding section operates in a preferred embodiment of the present invention.

FIG. 13 is a block diagram showing a charge pump and a loop filter according to a preferred embodiment of the present invention.

FIG. 14 is a timing diagram showing how the clock signal generator operates in a preferred embodiment of the present invention.

FIG. 15 is a timing diagram showing how the clock signal generator operates in a preferred embodiment of the present invention.

FIG. 16 is a timing diagram showing how the clock signal generator operates in a preferred embodiment of the present invention.

FIG. 17 is a timing diagram showing how the clock signal generator operates in a preferred embodiment of the present invention.

FIG. 18 is a timing diagram showing how the clock signal generator operates in a preferred embodiment of the present invention.

FIG. 19 is a timing diagram showing how the clock signal generator operates in a preferred embodiment of the present invention.

FIG. 20 is a block diagram showing an optical disk drive according to another preferred embodiment of the present invention.

FIG. 21 is a block diagram showing an optical disk drive according to another preferred embodiment of the present invention.

FIG. 22 is a block diagram showing a phase error adding section according to a preferred embodiment of the present invention.

FIG. 23 is a table showing how to control the ratios of two types of phase errors to be added together in a preferred embodiment of the present invention.

FIG. 24 is a timing diagram showing how the clock signal generator operates in a preferred embodiment of the present invention.

FIG. 25 is a timing diagram showing how the clock signal generator operates in a preferred embodiment of the present invention.

FIG. 26 is a block diagram showing an optical disk drive according to a preferred embodiment of the present invention.

FIG. 27 is a block diagram showing a phase error adding section according to a preferred embodiment of the present invention.

FIG. 28 is a table showing how to control the ratios of two types of phase errors to be added together in a preferred embodiment of the present invention.

FIG. 29 is a timing diagram showing how the clock signal generator operates in a preferred embodiment of the present invention.

FIG. 30 is a block diagram showing a conventional optical disk drive.

### DESCRIPTION OF REFERENCE NUMERALS

100 optical disk medium
101 optical head section
102 motor
103 servo circuit
104 analog signal processing section
105 power control section
106 data modulating section
107 ADIP reading section
108 read/write access control section
109 CPU
110 data binarizing section
111 data demodulating section
112 LPP reading section
113 header detecting and interpolating section
120 clock signal generator
120a wobble phase error detecting section
120b data phase error detecting section
120c frequency control section
121 A/D converter
122 amplitude detecting section
123 BPF
124 frequency divider counter
125 phase error detecting section
126 lock decision section
127 A/D converter
128 interpolation filter
129 phase error detecting section
130 phase-locking control section
131 amplitude detecting section
132 phase error adding section
133 charge pump
134 loop filter
135 VCO
136 loop filter
137 VCO
200, 201, 202, 203, 204 multiplier
205 wobble phase error gain selector
206 data phase error gain selector
207 state decision section
208 phase error counter
209 pulse converting section
300, 301, 302, 303, 304, 305 delay element
306, 307, 308, 309, 310, 311, 312 multiplier
313 adder
400 multiplier
401 adder
402 delay element
403 64 step normalizer
404 interpolation filter tap coefficient selector

### BEST MODE FOR CARRYING OUT THE INVENTION

Hereinafter, preferred embodiments of the present invention will be described with reference to the accompanying drawings. In the drawings, any pair of components shown in multiple drawings and having substantially the same function is identified by the same reference numeral. And once a component has been described, the description of its counterpart will be omitted herein to avoid redundancies.

### Embodiment 1

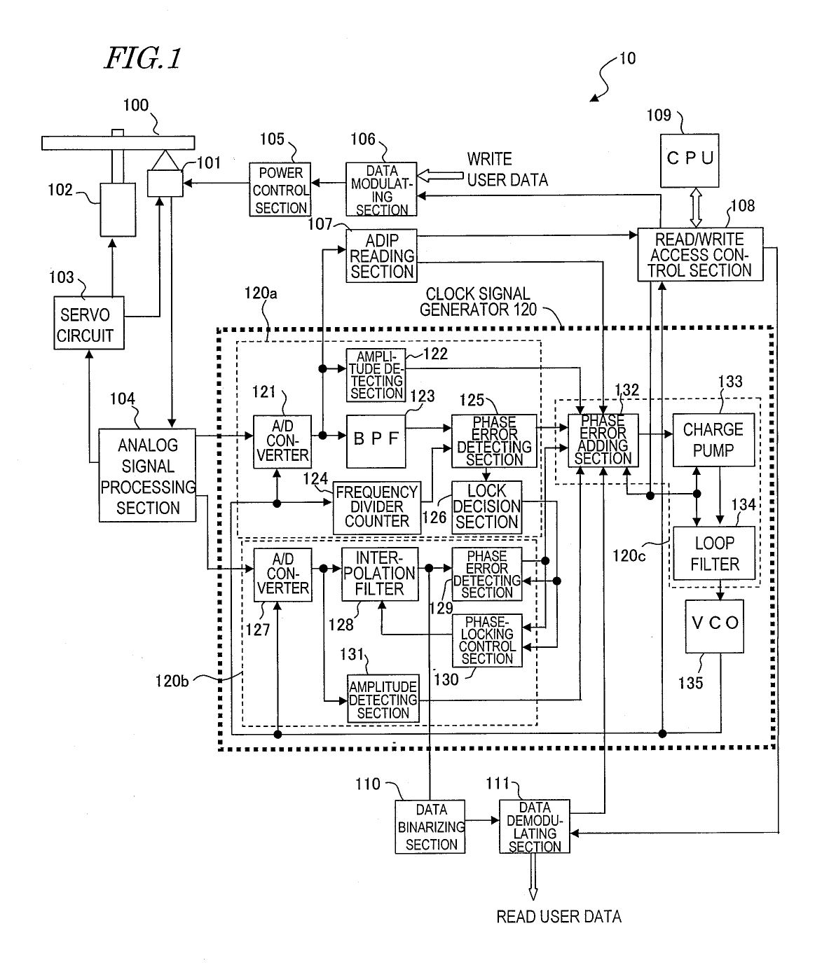

FIG. 1 is a block diagram showing a configuration for an optical disk drive 10 according to a first specific preferred embodiment of the present invention.

The optical disk drive 10 reads and writes data from/on an optical disk medium 100 using a clock signal that has been generated from the optical disk medium 100 on which information is stored. The optical disk drive 10 includes an optical head section 101, a motor 102, a servo circuit 103, an analog signal processing section 104, a power control section 105, a data modulating section 106, an ADIP reading section 107, a read/write access control section 108, a CPU 109, a data binarizing section 110, a data demodulating section 111 and a clock signal generator 120.

The optical disk medium 100 has a wobbled track that wobbles in a predetermined period. On the track, information has been written in a prescribed data format. To write information at a predetermined location on a storage layer of the optical disk medium 100, ADIP is arranged along the track. Wobble modulation marks, made by the MSK modulation, are arranged in the prescribed format on the ADIP, thereby representing address information.

FIG. 3(a) shows the data format of information to be written on the optical disk medium 100. The user data to be written is modulated by a predetermined modulation method so as to form sectors and is written on the optical disk medium 100 on a 16 sector basis. Between the end position of the data already stored and the start position of the data to be newly written right after that, a buffer area is provided for each writing unit. Thus, even if the phases of a read signal is discontinuous between the writing units when data should be read continuously, the optical disk drive can get ready to read the next sector with stability while processing the buffer area. As a result, in writing new data, there is no need to synchronize the phases of the previous stored data and the data to be newly written.

The optical head section 101 irradiates the optical disk medium 100 with a light beam and detects the intensity of the light that has been reflected from the optical disk medium 100 to output an electrical signal while scanning the track. The analog signal processing section 104 extracts, from the electrical signal, a wobble signal representing the wobbled pattern of the track, a data signal representing the data stored on the track, and a servo error signal representing the condensing state of the light beam on the track.

The motor 102 rotates the optical disk medium 100 at a rotational frequency specified. Using the servo error signal, the servo circuit 103 controls the optical head section 101 such that the light beam can maintain the best condensing and scanning states. Also, based on the radial location on the optical disk medium 100 irradiated with the light beam and on the frequency of the wobble signal that has been extracted by the analog signal processing section 104, the servo circuit 103 controls the rotational frequency of the motor 102 such that the frequency can be as close to its best value as possible.

The clock signal generator 120 generates a clock signal, of which the phase is locked to that of the wobble signal and of which the frequency is synchronized with that of the data signal. Also, the clock signal generator 120 generates and outputs a digital wobble signal by sampling the wobble signal in response to the clock signal generated. Furthermore, the clock signal generator generates a digital data signal by sampling the data signal and corrects the phase of the digital data signal, thereby outputting a corrected data signal.

The ADIP reading section 107 detects a signal representing a wobble modulated mark that has been subjected to the MSK modulation from the digital wobble signal to read address information. Based on that address information, the read/write access control section 108 controls the timing to read and write data from/on the optical disk medium 100.

The data modulating section 106 modulates write user data to be written on the optical disk medium 100 by a predetermined modulation method, thereby generating a write data signal and outputting the signal at the timing specified by the read/write access control section 108.

The power control section 105 controls the power of the light beam of the optical head section 101. Specifically, in writing, the power control section 105 controls the power in accordance with the write data signal that has been supplied from the data modulating section 106.

The data binarizing section 110 performs not only partial response equalization on an interpolated data signal (to be described in detail later) but also maximum likelihood decoding according to the type of the partial response, thereby outputting a binarized data signal. The data demodulating section 111 demodulates the binarized data signal by a predetermined demodulation method at a timing specified by the read/write access control section 108, thereby outputting read user data.

The CPU 109 instructs the optical disk drive to perform a read/write operation by way of the read/write timing controller 108.

Next, the clock signal generator 120 will be described.

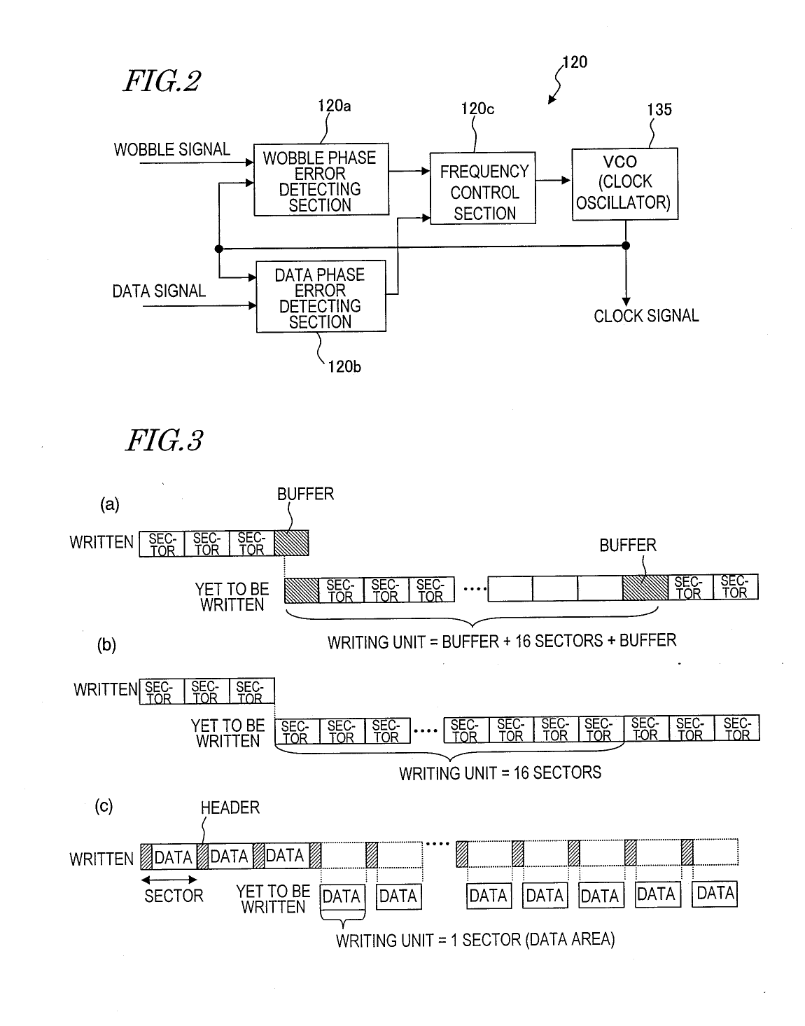

FIG. 2 shows the clock signal generator 120, which includes a wobble phase error detecting section 120a, a data phase error detecting section 120b, a frequency control section 120c and a VCO (clock oscillation section) 135.

The wobble phase error detecting section 120a detects a wobble phase error that is a difference in phase between a wobble signal, representing the wobbled shape of the track, and the clock signal. On the other hand, the data phase error detecting section 120b detects a data phase error that is a difference in phase between a data signal, representing data that has been written on the optical disk medium 100, and the clock signal.

The frequency control section 120c generates a frequency control section based on the sum of the wobble phase error and the data phase error. In this case, the frequency control section 120c adds these two errors together with the ratios of the wobble and data phase errors changed according to some parameter of the wobble and data signals. For example, the frequency control section 120c may change the ratios according to the qualities of the wobble and data signals or how closely at least one of the wobble and data signals is synchronized with the clock signal. Alternatively, the frequency control section 120c may also change the ratios according to the mode of operation of the optical disk drive 10. It will be described in further detail later exactly how to change the ratios. The VCO 135 generates a clock signal with a frequency defined by the frequency control signal supplied from the frequency control section 120c.

Hereinafter, the clock signal generator 120 will be described in further detail with reference to FIG. 1. The wobble phase error detecting section 120a includes an A/D converter 121, an amplitude detecting section 122, a band-pass filter (BPF) 123, a frequency divider counter 124, a phase error detecting section 125 and a lock decision section 126. On the other hand, the data phase error detecting section 120b includes an A/D converter 127, an interpolation filter 128, a phase error detecting section 129, a phase-locking control section 130, and an amplitude detecting section 131. The frequency control section 120c includes a phase error adding section 132, a charge pump 133 and a loop filter 134.

First, it will be described how the clock signal generator detects the wobble phase error.

The A/D converter 121 functions as a sampling section for sampling the wobble signal in response to the clock signal that has been generated by the VCO 135, generates a binarized digital wobble signal and outputs it to the amplitude detecting section 122 and the BPF 123.

The amplitude detecting section 122 adds together the absolute values of the digital wobble signal every predetermined period and regards the sum as an amplitude detected value. If the amplitude detected value is smaller than a predetermined threshold value, the amplitude detecting section 122 detects a wobble amplitude error.

The BPF 123 extracts wobble frequency components from the digital wobble signal and generates and outputs a binarized wobble signal that has been binarized with respect to a predetermined threshold value.

The frequency divider counter 124 is a counter for dividing the frequency of the clock signal by K according to the wobble period. If K is an odd number, the counter 124 repeatedly counts from −K/2 through K/2 a number of times. On the other hand, if K is an even number, the counter 124 repeatedly counts from −K/2 through K/2−1 a number of times.

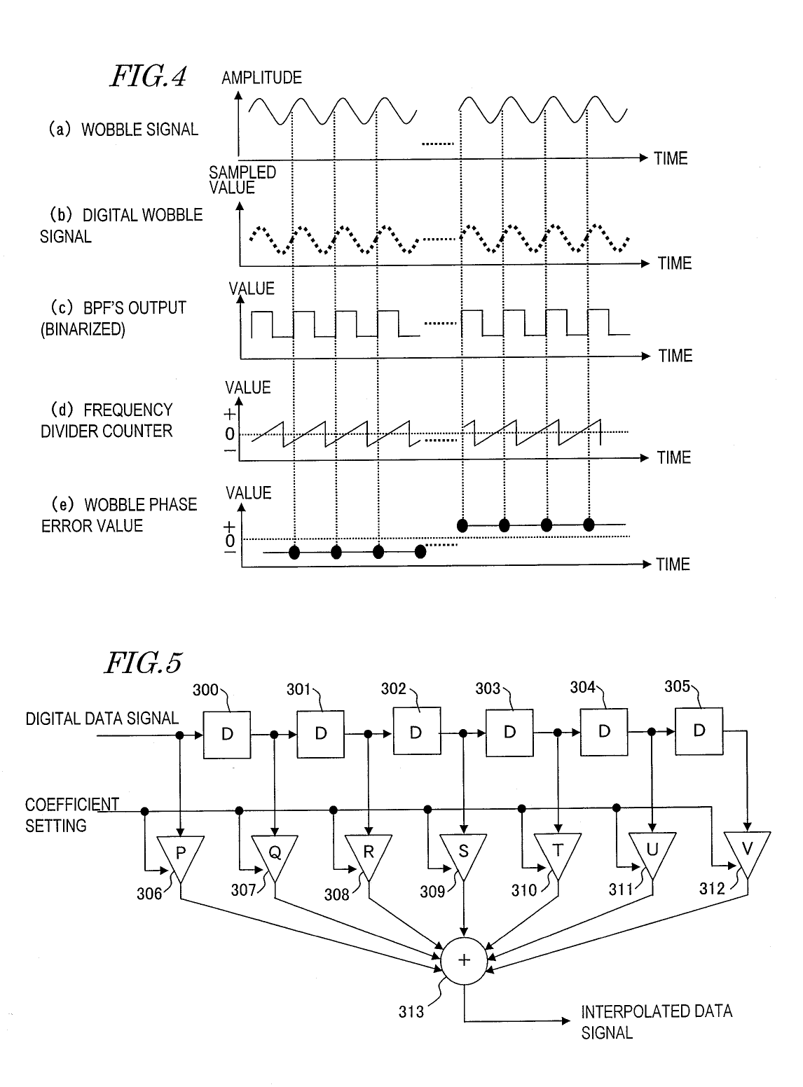

The phase error detecting section 125 detects a phase error between the binarized wobble signal and the count of the frequency divider counter 124. FIG. 4 is a timing diagram showing how the phase error detecting section 125 detects the wobble phase error. Specifically, portion (a) of FIG. 4 shows the wobble signal that has been extracted by the analog signal processing section 104 and that will be input to the A/D converter 121. Portion (b) of FIG. 4 shows a digital wobble signal that has been output from the A/D converter 121. The digital wobble signal is then converted by the BPF 123 into the binarized wobble signal shown in portion (c) of FIG. 4. Portion (d) of FIG. 4 shows how the count of the frequency divider counter 124 changes. On every leading edge of the binarized wobble signal shown in portion (c) of FIG. 4, the phase error detecting section 125 latches the count of the frequency divider counter as shown in portion (d) of FIG. 4 and outputs the latched value as the wobble phase error value shown in portion (e) of FIG. 4. A negative wobble phase error value indicates that the phase of the frequency divider counter 124 (i.e., the phase of the clock signal) is lagging behind that of the wobble signal. On the other hand, a positive wobble phase error value indicates that the phase of the clock signal is leading ahead of that of the wobble signal. In any case, the frequency of the clock signal supplied from the VCO 135 is controlled such that the wobble phase error becomes equal to zero.

The lock decision section 126 determines whether or not the phases of the wobble signal and the clock signal agree with each other. It is determined that phase locking has been accomplished if the absolute value of the wobble phase error detected by the phase error detecting section 125 is smaller than a predetermined lock detection threshold value all through a prescribed period. However, if the absolute value of the wobble phase error is greater than a predetermined unlock detection threshold value all through the prescribed period after it has once been determined that phase locking has been accomplished, then the lock decision section 126 determines that the phase has been unlocked.

Next, it will be described how the clock signal generator detects the data phase error. When the A/D converter 127 is sampling the data signal, the phases of the data signal and the clock signal do not agree with each other. That is why the digital data signal, generated by the A/D converter 127 that has sampled the data signal, is reproduced by the interpolation filter 128 into an interpolated data signal in the phase locked state. Then, the phase error is detected based on the interpolated data signal and the filter coefficient of the interpolation filter 128 is controlled so as to reduce the phase error. The data phase error detection operation is carried out by such a digital phase-locked loop. Interpolation of data is disclosed in Japanese Patent Publication No. 3486145, for example.

The A/D converter (sampling section) 127 samples the data signal in response to the clock signal that has been generated by the VCO 135, thereby outputting a digital data signal, which is a digitized version of the data signal, to the amplitude detecting section 131 and the interpolation filter 128.

The amplitude detecting section 131 adds together the absolute values of the digital data signal every predetermined period and regards the sum as an amplitude detected value. If the amplitude detected value is smaller than a predetermined threshold value, the amplitude detecting section 131 detects a data amplitude error.

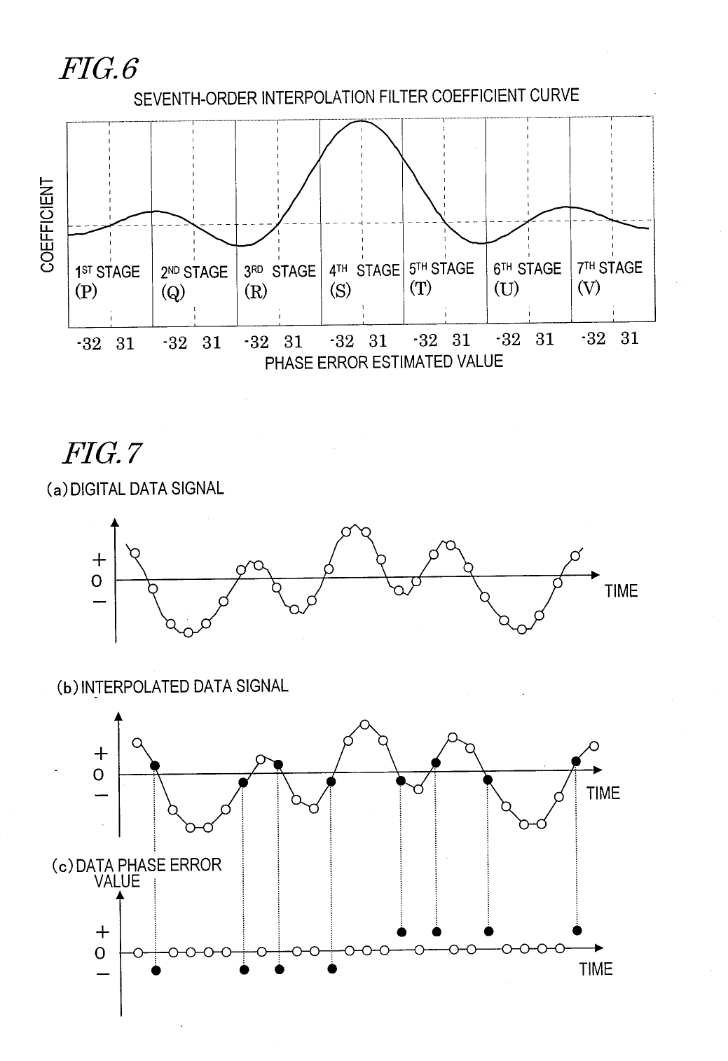

The interpolation filter 128 is an FIR (finite impulse response) filter for reproducing an interpolated data signal in the phase-locked state from the digital data signal that has been sampled in the phase-unlocked state. FIG. 5 is a block diagram showing the interpolation filter 128, which is an FIR filter including delay elements 300 through 305 that are connected in series together, multipliers 306 through 312 that are also connected in series together, and an adder 313. The delay elements 300 through 305 delay the digital data signal value every period of the clock signal. Each of the multipliers 306 through 312 multiplies the value of its associated delay element by an associated one of tap coefficients P through V. The adder 313 adds together the respective outputs of the multipliers, thereby outputting an interpolated data signal. The tap coefficients P through V are determined based on the Nyquist interpolation characteristic shown in FIG. 6, for example.

The phase error detecting section 129 (digital data phase error detecting section) detects a data phase error value from the interpolated data signal. FIG. 7 is a timing diagram showing how the phase error detecting section 129 operates. Specifically, portion (a) of FIG. 7 shows the digital data signal that has been sampled in the phase-unlocked state. The interpolation filter 128 reproduces the interpolated data signal shown in portion (b) of FIG. 7 from the digital data signal shown in portion (a) of FIG. 7. A point with the smaller absolute value (as indicated by the solid circle in portion (b) of FIG. 7) is extracted as a zero-cross position from the two values that interpose the zero-cross point of the interpolated data signal. As shown in portion (c) of FIG. 7, if the position displaces on a leading edge, the phase error detecting section 129 uses that value as a data phase error value as it is. On the other hand, if the position displaces on a trailing edge, the phase error detecting section 129 multiplies that value by −1 and outputs the product as the data phase error value. A negative data phase error value indicates that the phase reproduced by the interpolation filter 128 is lagging behind the phase-locked state, while a positive data phase error value indicates that the phase is leading ahead of the phase locked state.

The phase-locking control section 130 smoothes the data phase error values, normalizes the phase error into 64 steps based on the smoothed value, and determines the tap coefficients P through V of the interpolation filter 128 on a step-by-step basis. The tap coefficients P through V are determined based on the Nyquist interpolation characteristic shown in FIG. 6.

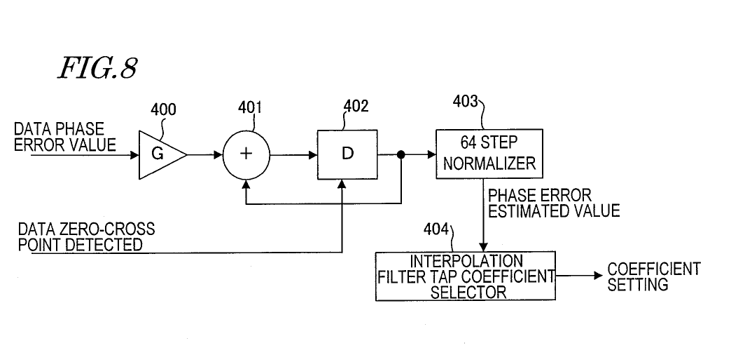

FIG. 8 is a block diagram showing the phase-locking control section 130. The data phase error value that has been detected by the phase error detecting section 129 is input to a multiplier 400 that has a predetermined gain G, and then smoothed by an integrator consisting of an adder 401 and a delay element 402, which latches the output value of the adder 401 every time a data zero-cross point is detected. The greater the gain value G, the greater the loop gain of the digital phase-locked loop. That is to say, as the gain value G is decreased, the loop gain will decrease, too. The gain value G is defined such that the digital phase-locked loop can maintain the phase-locked state. The smoothed data phase error value is converted by a 64 step normalizer 403 into a value of −32 into 31 and is output as a phase error decision value. An interpolation filter tap coefficient selector 404 determines and updates the seven tap coefficients P through V of the interpolation filter 128 in accordance with the Nyquist interpolation characteristic.

As described above, the phase-locking control section 130 controls the filter coefficient of the interpolation filter based on the phase error value such that the interpolated phase agrees with the synchronous sampling state. The VCO 135 for generating a clock signal as an operating clock signal for the data PLL generates either a clock signal with a fixed frequency or a clock signal with such a frequency that makes the phase error fall within a phase locking controllable range.

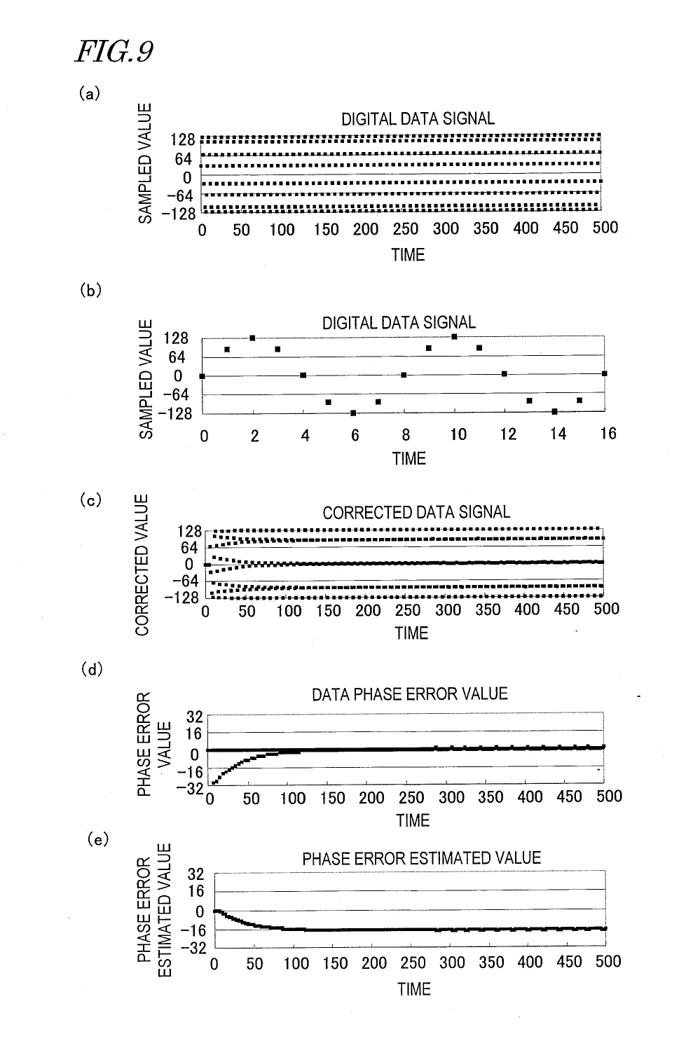

FIG. 9 is a timing diagram showing how the digital phase-locked loop operates to perform data signal processing. The input data signal is supposed to be a sine wave with a period of 8T (i.e., a sine wave, of which one period is equal to eight periods of a clock signal).

Specifically, portion (a) of FIG. 9 shows a digital data signal that has been sampled in the phase-unlocked state by the A/D converter 127. Portion (b) of FIG. 9 shows sampled values of the digital data signal in the phase-locked state. These sample points overlap with the central level (zero level) of a sine wave in the phase-locked state, but not in the phase-unlocked state shown in portion (a) of FIG. 9.

Portion (c) of FIG. 9 shows a corrected data signal that has been generated by the interpolation filter 128. Portion (d) of FIG. 9 shows data phase error values that have been detected by the phase error detecting section 129. And portion (e) of FIG. 9 shows phase error decision values that have been output by the phase-locking control section 130. The phase error decision value begins with the initial state (zero), when the corrected data signal (see portion (c) of FIG. 9) is not in the phase-locked state, and therefore, a non-zero data phase error value (see portion (d) of FIG. 9) is output. The phase error decision value (see portion (e) of FIG. 9) changes with the data phase error value (see portion (d) of FIG. 9) and the tap coefficient of the interpolation filter 128 is controlled. As the data phase error value (see portion (d) of FIG. 9) gradually converges to zero, the phase error decision value (see portion (e) of FIG. 9) is also going to converge toward a constant value. As a result, the interpolation filter 128 is controlled such that the interpolated data signal (see portion (c) of FIG. 9) generated by the interpolation filter 128 maintains the phase-locked state.

Next, the phase error adding section 132, charge pump 133, loop filter 134 and VCO 135 will be described.

The phase error adding section 132 adds together the wobble phase error and data phase error with the ratios of these two phase errors controlled. Based on the sum, the phase error adding section 132 outputs either an UP pulse signal to increase the frequency of the clock signal or a DOWN pulse signal to decrease the frequency of the clock signal.

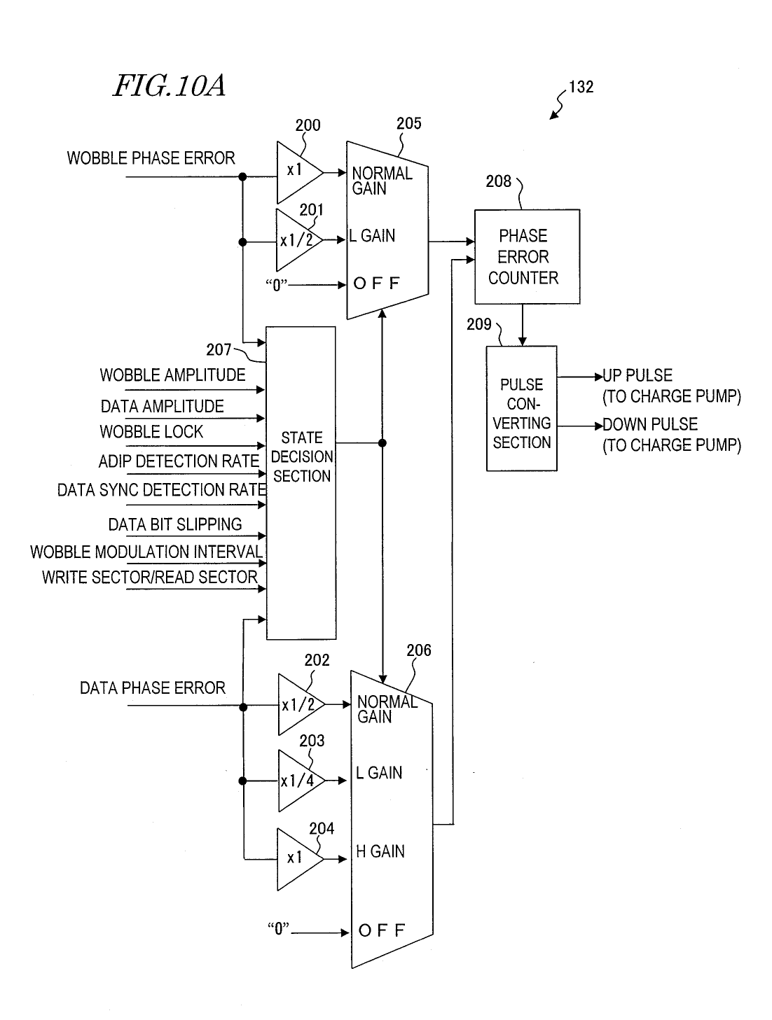

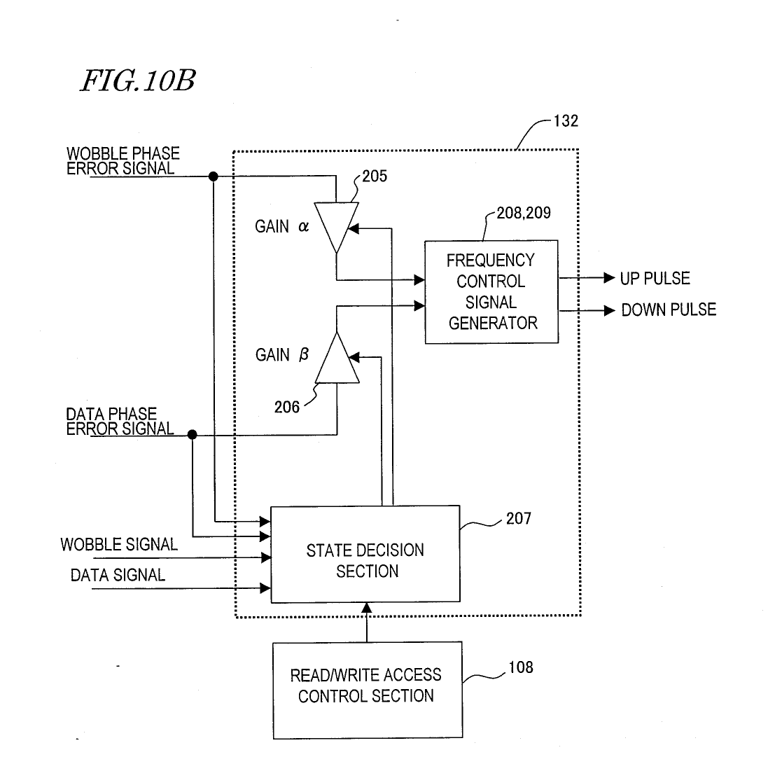

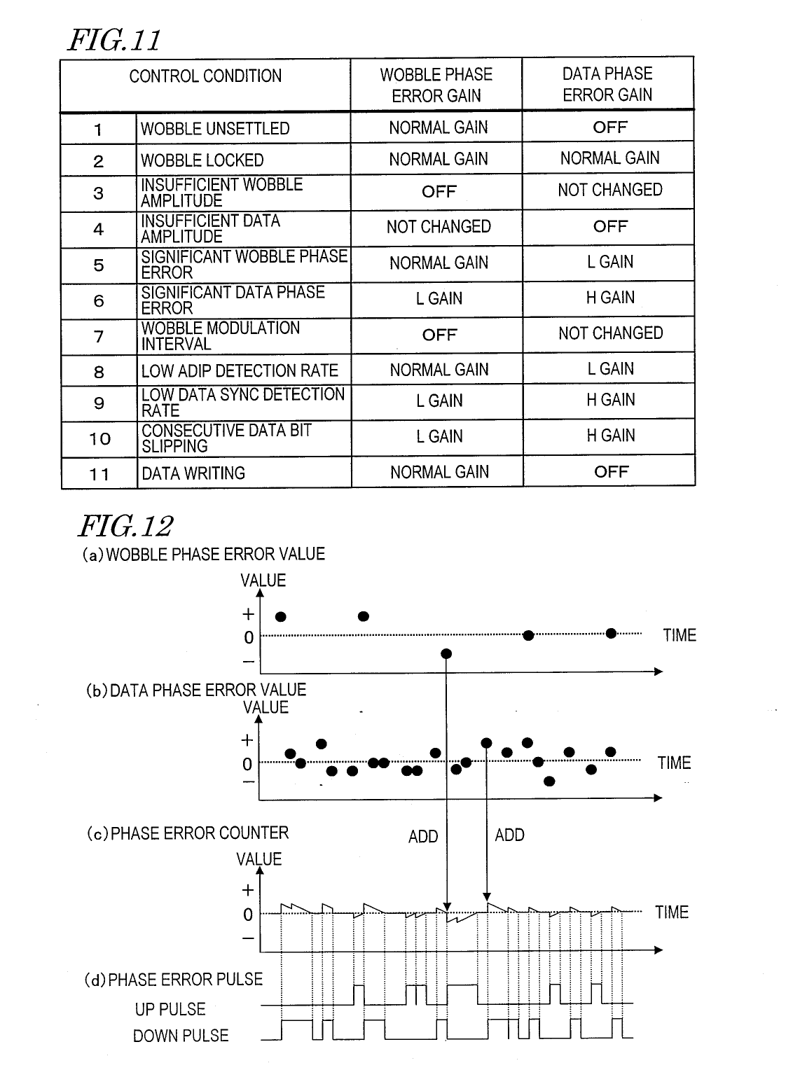

FIG. 10A is a block diagram showing the phase error adding section 132, which includes multipliers 200 to 204, a wobble gain selector 205 for changing the ratios of the wobble phase error, a data gain selector 206 for changing the ratios of the data phase error, a state decision section 207 for determining the logic of selection between the wobble gain selector 205 and the data gain selector 206, a phase error counter 208 that operates while adding together the wobble and data phase errors that have had their gains controlled, and a pulse converting section 209 for selectively outputting an UP pulse signal or a DOWN pulse signal according to the count of the phase error counter 208.

FIG. 10B schematically shows the phase error adding section 132. The state decision section 207 determines the states of respective signals by the wobble signal, the data signal, the wobble phase error and the data phase error, and controls the wobble phase error gain and the data phase error gain based on the result of the state decision. The state decision section 207 also controls the wobble phase error gain and the data phase error gain according to the operation status of the optical disk drive 10 that has been provided by the read/write access control section 108.

A wobble gain selector 205 multiplies the wobble phase error signal by a controlled gain α and outputs a signal representing the product. A data gain selector 206 multiplies the data phase error signal by a controlled gain β and outputs a signal representing the product. And frequency control signal generators 208 and 209 generate frequency control signals based on the respective output signals of the wobble gain selector 205 and the data gain selector 206.

FIG. 11 is a table showing the logic with which the state decision section 207 switches the wobble phase error gain and the data phase error gain.

Control conditions (1) and (2) shown in FIG. 11 will be described. When the phase of the wobble signal is not locked to that of the clock signal yet (e.g., while the wobble signal is still unsettled), the phase error adding section 132 sets the ratio of the data phase error to be lower than that of the wobble phase error. While the wobble lock signal supplied from the lock decision section 126 indicates that the phase of the wobble signal has not been locked to that of the clock signal yet, the phase error adding section 132 is in the “wobble unsettled” state (which is control condition (1)). In that state, the wobble phase error gain is a normal gain (e.g., 1×), the data phase error gain is turned OFF, the frequency of the clock signal is controlled with only the wobble phase error, and the best condition is established for the wobble signal.

Once phase locking has been accomplished, the phase error adding section 132 increases the ratio of the data phase error compared to the previous unlocked state. If the wobble lock signal indicates that phase locking has been accomplished, the “wobble locked” state (which is control condition (2)) is established. In that state, the wobble phase error is a normal gain, so is the data phase error gain (e.g., ½×), the frequency of the clock signal is controlled with both the wobble phase error and the data phase error, and both the wobble signal and the data signal can be read at the same time.

Next, control conditions (3) and (4) will be described. If the amplitude of the wobble signal is smaller than a predetermined first threshold value, the phase error adding section 132 sets the ratio of the wobble phase error to be lower than that of the data phase error. Also, if the wobble amplitude value supplied from the wobble signal amplitude detecting section 122 is smaller than a predetermined threshold value, the phase error adding section 132 determines that the wobble signal is not read normally, thus determining that this is “insufficient wobble amplitude” state (which is control condition (3)). In that state, the wobble phase error gain is turned OFF but the data phase error gain is not changed but stays put. As a result, in an area of the optical disk medium 100 where the wobble signal cannot have its normal amplitude due to the presence of a scratch or finger mark on the track, the wobble signal has low reliability, and therefore, the wobble phase error is not used to control the frequency of the clock signal.

Also, if the amplitude of the data signal is smaller than a predetermined second threshold value, the phase error adding section 132 sets the ratio of the data phase error to be lower than that of the wobble phase error. Also, if the data amplitude value supplied from the data signal amplitude detecting section 131 is smaller than a predetermined threshold value, the phase error adding section 132 determines that the data signal is not read normally, thus determining that this is “insufficient data amplitude” state (which is control condition (4)). In that state, the data phase error gain is turned OFF but the wobble phase error gain is not changed but stays put. As a result, in an area of the optical disk medium 100 where the data signal cannot have its normal amplitude due to the presence of a scratch or finger mark on the track or in an area where data has not been written properly due to insufficient power of the light beam that was used to write the data, the data signal has low reliability, and therefore, the data phase error is not used to control the frequency of the clock signal.

Next, control conditions (5) and (6) will be described. If the absolute value of the wobble phase error is greater than a predetermined third threshold value, the phase error adding section 132 sets the ratio of the wobble phase error to be higher than that of the data phase error. Also, if the absolute value of the wobble phase error supplied from the phase error detecting section 125 continues to be greater than a predetermined threshold value all through a prescribed period, the phase error adding section 132 determines that control over the wobble signal has loosened, thus determining that this is “significant wobble phase error” state (which is control condition (5)). In that state, the wobble phase error gain is supposed to be a normal gain but the data phase error gain is supposed to be an L gain (e.g., ¼×). As a result, when the frequency of the clock signal is controlled, the control is much less affected by the data phase error but is now affected more significantly by the wobble phase error, thus tightening the control over the wobble signal.

On the other hand, if the absolute value of the data phase error is greater than a predetermined fourth threshold value, the phase error adding section 132 sets the ratio of the data phase error to be higher than that of the wobble phase error. Also, if the absolute value of the data phase error supplied from the phase error detecting section 129 continues to be greater than a predetermined threshold value all through a prescribed period, the phase error adding section 132 determines that control over the data signal has loosened, thus determining that this is “significant data phase error” state (which is control condition (6)). In that state, the wobble phase error gain is supposed to be an L gain (e.g., ½×) and the data phase error gain is supposed to be an H gain (e.g., 1×). As a result, when the frequency of the clock signal is controlled, the control is much less affected by the wobble phase error but is now affected more significantly by the data phase error, thus tightening the control over the data signal.

Next, control condition (7) will be described. A part of the wobbled shape of the track has been subjected to either a frequency modulation or a phase modulation. In an interval in which a wobble signal, representing such a modulated wobble shape, is detected, the phase error adding section 132 sets the ratio of the wobble phase error to be lower than that of the data phase error. Then, a wobble modulation interval signal is supplied from the ADIP reading section 107 to the phase error adding section 132. The wobble modulation interval signal is a gate signal to be output in an interval in which a wobble modulation mark should be detected once the ADIP reading section 107 has fixed a synchronous position with respect to the ADIP. When the wobble modulation interval signal is received, the “wobble modulation interval” state, which is control condition (7), is entered. In that state, the wobble phase error gain is turned OFF. As a result, the wobble phase error in the interval of the wobble modulation mark gets masked, and therefore, is no longer affected by those disturbance factors such as frequency modulation and phase modulation of the wobble shape.

Next, control condition (8) will be described. If the detection rate of the wobble shape that has been subjected to either frequency modulation or phase modulation is lower than a predetermined threshold value, the phase error adding section 132 sets the ratio of the wobble phase error to be higher than that of the data phase error. Also, if the ADIP detection rate provided by the ADIP reading section 107 continues to be lower than a predetermined threshold value all through a prescribed period, the phase error adding section 132 determines that control over the wobble signal has loosened and is now affecting ADIP reading, thus determining that this is “low ADIP detection rate” state (which is control condition (8)). In that state, the wobble phase error gain is supposed to be a normal gain but the data phase error gain is supposed to be an L gain. As a result, when the frequency of the clock signal is controlled, the control is much less affected by the data phase error but is now affected more significantly by the wobble phase error, thus tightening the control over the wobble signal and increasing the ADIP detection rate.

Next, control condition (9) will be described. On the track of the optical disk medium 100, arranged at regular intervals are frame sync marks. If the detection rate of the frame sync marks is lower than a predetermined threshold value, the phase error adding section 132 sets the ratio of the data phase error to be higher than that of the wobble phase error. The data demodulating section 111 detects data SYNC marks that are arranged in a predetermined modulation format at regular intervals from the binarized data signal and provides the detection rate (i.e., data SYNC detection rate) for the phase error adding section 132. If the data SYNC detection rate continues to be lower than a predetermined threshold value all through a prescribed period, the phase error adding section 132 determines that control over the data signal has loosened and is now affecting data reading, thus determining that this is “low data SYNC detection rate” state (which is control condition (9)). In that state, the wobble phase error gain is supposed to be an L gain but the data phase error gain is supposed to be an H gain. As a result, when the frequency of the clock signal is controlled, the control is much less affected by the wobble phase error but is now affected more significantly by the data phase error, thus tightening the control over the data signal and increasing the data SYNC detection rate.

Next, control condition (10) will be described. If the interval at which the frame sync marks are detected is either longer or shorter than the regular interval, the phase error adding section 132 sets the ratio of the data phase error to be higher than that of the wobble phase error. The data demodulating section 111 determines, by the data SYNC detection interval, whether or not bit slipping has occurred in the binarized data signal. If bit slipping has occurred a predetermined number of times in a row, the phase error adding section 132 determines that control over the data signal has loosened and is now affecting data reading, thus determining that this is “consecutive data bit slipping” state (which is control condition (10)). In that state, the wobble phase error gain is supposed to be an L gain but the data phase error gain is supposed to be an H gain. As a result, when the frequency of the clock signal is controlled, the control is much less affected by the wobble phase error but is now affected more significantly by the data phase error, thus tightening the control over the data signal and reducing the occurrence of bit slipping.

Next, control condition (11) will be described. A timing signal, indicating whether the current location being processed is a write sector or a read sector, is supplied from the read/write access control section 108 to the phase error adding section 132. If it is a read sector, the phase error adding section 132 operates under the control conditions (1) through (10) described above. On the other hand, if it is a write sector, “data writing” state, which is control condition (11), is entered. In that state, the wobble phase error gain is supposed to be a normal gain but the data phase error gain is turned OFF, thereby controlling the frequency of the clock signal with only the wobble signal and writing data synchronously with wobbling of the track. In this manner, in writing data on the optical disk medium 100, the phase error adding section 132 sets the ratio of the data phase error to be lower than that of the wobble phase error.

Next, the phase error counter 208 that receives the gain-controlled wobble and data phase errors and adds them together (see FIG. 10A) and the pulse converting section 209 for converting the sum into an UP pulse signal and a DOWN pulse signal that control the charge pump 133 (see FIG. 1) will be described.

FIG. 12 is a timing diagram showing how the phase error counter 208 and the pulse converting section 209 operate. Specifically, portion (a) of FIG. 12 shows the gain-controlled wobble phase error values, which are output on the leading edges of the binarized wobble signal but remain zero at the other times. Portion (b) of FIG. 12 shows the gain-controlled data phase error values, which are output at the zero-cross points of the corrected data signal but remain zero at the other times. Portion (c) of FIG. 12 shows the counting operation performed by the phase error counter 208. If the count is greater than zero, the phase error counter 208 decrements its count one by one every period of the clock signal. On the other hand, if the count is smaller than zero, the phase error counter 208 increments its count one by one every period of the clock signal. And if the count is equal to zero, the phase error counter 208 puts its count on hold. By performing such a counting operation, the phase error counter 208 increases its count every time it has counted the wobble phase error or data phase error. That is why whenever a wobble phase error value is obtained, its count is incremented by one. Likewise, whenever a data phase error value is obtained, its count is also incremented by one. The phase error counter 208 performs its counting operation in a time and with a polarity that are defined by the sum of these two types of phase errors.

The pulse converter 209 outputs an UP pulse signal and a DOWN pulse signal according to the count of the phase error counter 208 as shown in portion (d) of FIG. 12. Specifically, if the count of the phase error counter 208 is greater than zero, it means that the phase of the clock signal is leading ahead of the wobble and data signals, and therefore, the pulse converter 209 outputs the DOWN pulse signal instructing that the frequency of the clock signal be decreased. On the other hand, if the count of the phase error counter 208 is smaller than zero, it means that the clock signal has a phase lag, and therefore, the pulse converter 209 outputs the UP pulse signal instructing that the frequency of the clock signal be increased. And if the count of the phase error counter 208 is equal to zero, it means that the phase of the clock signal agrees with that of the wobble and data signals, and therefore, the pulse converter 209 outputs neither the UP pulse signal nor the DOWN pulse signal.

The charge pump 133 controls the amount of current to output, and eventually the voltage to charge the loop filter 134 with, in accordance with the UP and DOWN pulse signals supplied from the pulse converting section 209. And the VCO 135 generates a clock signal with a frequency associated with the voltage to charge the loop filter 134 with.

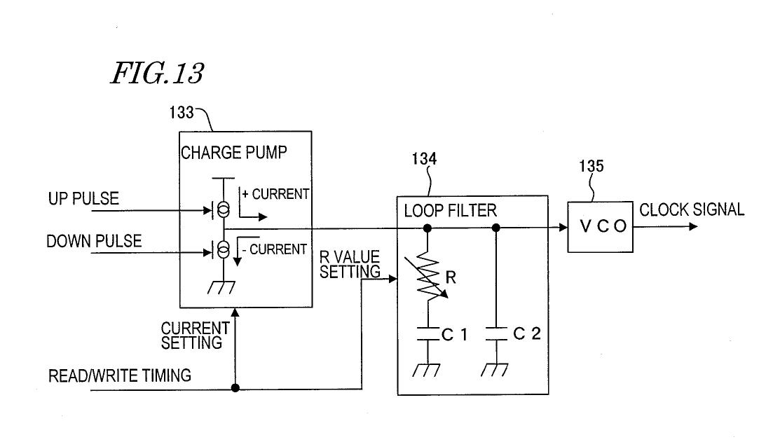

FIG. 13 is a block diagram showing the charge pump 133 and the loop filter 134. The charge pump 133 operates in such a manner as to pump out current responsive to the UP pulse signal and pump up current responsive to the DOWN pulse signal. The loop filter 134 is an RC low pass filter including a resistor R and two capacitors C1 and C2. If the charge pump 133 has pumped out current, the voltage to charge the capacitors C1 and C2 with will rise and the oscillation frequency of the VCO 135 will increase. Conversely, if the charge pump 133 has pumped up current, the voltage to charge the capacitors C1 and C2 with will fall and the oscillation frequency of the VCO 135 will decrease.

Also, the current value of the charge pump 133 and the resistance value of the resistor R of the loop filter are variable and changed in accordance with the read/write timing signal supplied from the read/write access control section 108. During writing, to reduce the variation in the frequency of the clock signal and thereby write data with good stability, as long as appropriate loop characteristic can be maintained, the current value is decreased and the resistance value R is increased as much as possible, thereby setting a low gain. On the other hand, during reading, to read data highly consistently by making the data signal follow the cloak signal more perfectly, as long as appropriate loop characteristic can be maintained, the current value is increased and the resistance value R is decreased as much as possible, thereby setting a high gain. As a result, the responsivity of the clock oscillation section 135 to the wobble and data phase errors becomes higher when data is read from the optical disk medium 100 than when data is written on the optical disk medium 100.

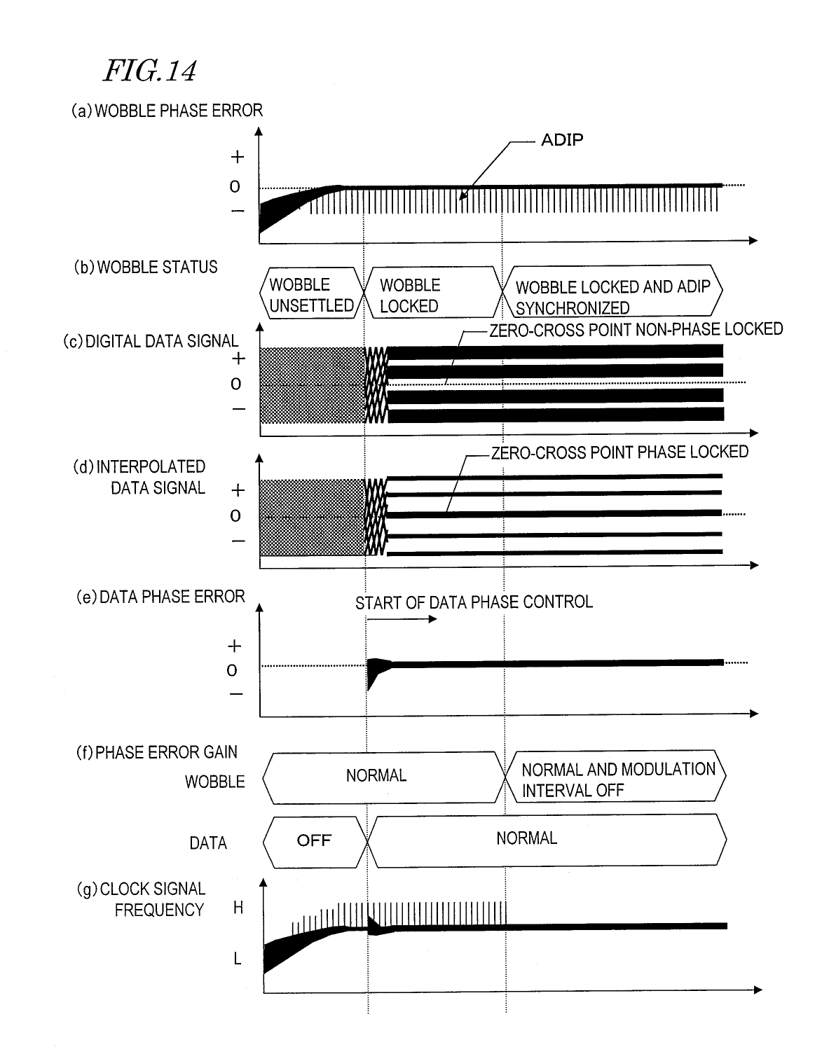

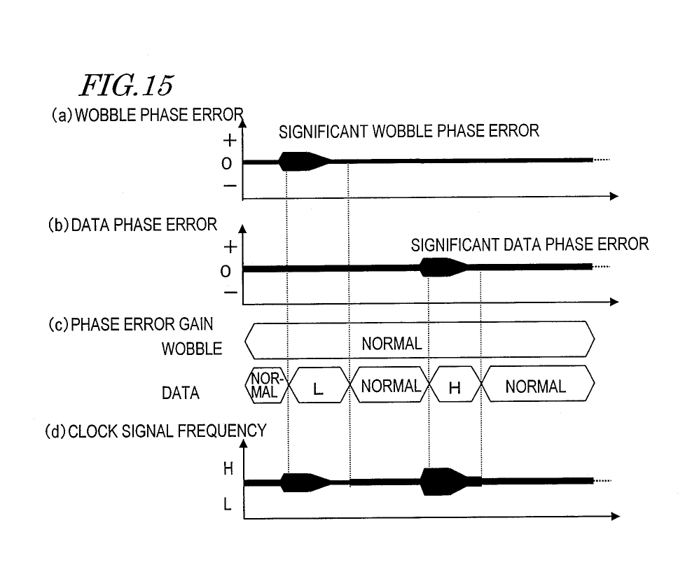

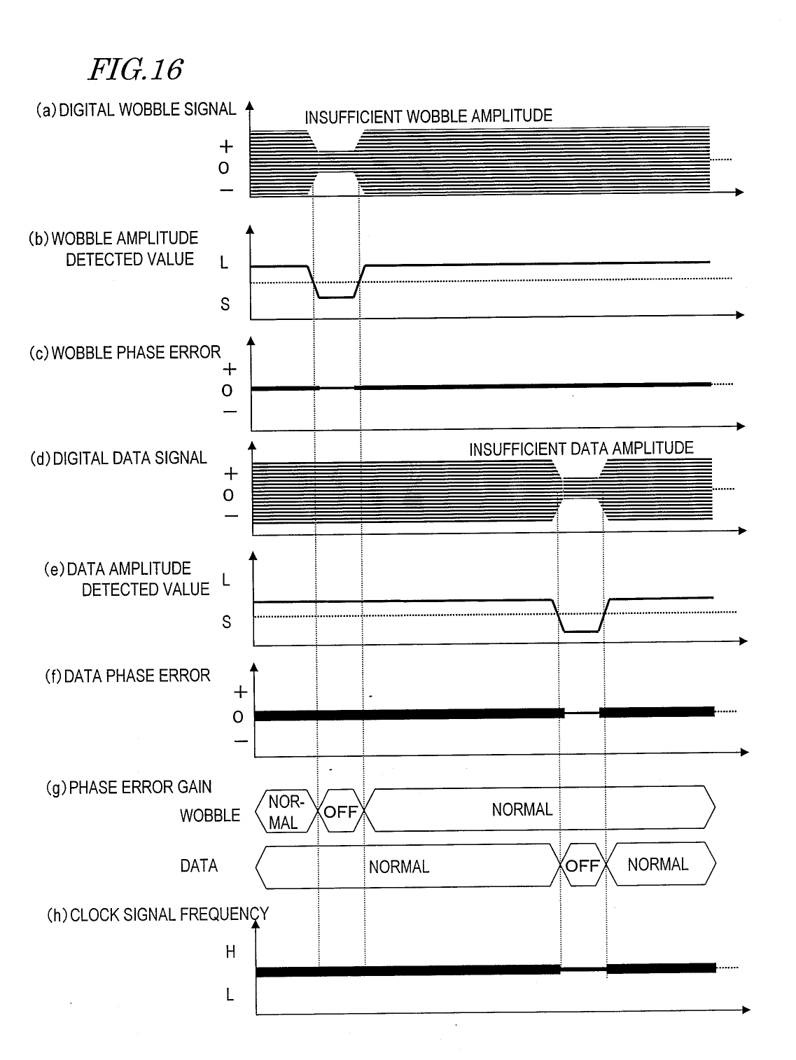

Hereinafter, it will be described with reference to FIGS. 14 through 19 how the clock signal generator with such a configuration operates.

FIG. 14 is a timing diagram showing how the clock signal generator operates in the wobble unsettled state, the wobble locked state and the wobble modulation interval. Specifically, portion (a) of FIG. 14 shows the wobble phase error detected by the phase error detecting section 125. Portion (b) of FIG. 14 shows wobble statuses representing the degrees of locking of the PLL that have been determined by the lock decision section 126 and the state of ADIP detection by the ADIP reading section 107. Portion (c) of FIG. 14 shows the digital data signal generated by the A/D converter 127. Portion (d) of FIG. 14 shows the interpolated data signal generated by the interpolation filter 128. Portion (e) of FIG. 14 shows the data phase error detected by the phase error detecting section 129. Portion (f) of FIG. 14 shows the respective gains of the wobble and data phase errors at the phase error adding section 132. And portion (g) of FIG. 14 shows the frequency of the clock signal generated by the VCO 135.

At the start point of the operation, the wobble status shown in portion (b) of FIG. 14 is the wobble unsettled state, and the negative wobble phase error value shown in portion (a) of FIG. 14 indicates that the clock signal has a phase lag. In such a state, the phase error gains at the phase error adding section 132 (see portion (f) of FIG. 14) include a data phase error gain in OFF state and a wobble phase error gain that is a normal gain. As a result, the frequency of the clock signal shown in portion (g) of FIG. 14 is controlled so as to increase gradually with the wobble phase error.

When the phase of the wobble signal substantially agrees with that of the clock signal, the wobble phase error shown in portion (a) of FIG. 14 becomes approximately equal to zero. And when the lock decision section 126 detects that state, the wobble status shown in portion (b) of FIG. 14 turns into the wobble locked state. Also, in such a state, the frequency of the wobble signal has been increased 1.5 times in the wobble modulation mark interval by the MSK modulation, and therefore, the wobble phase error value goes negative in that interval. The wobble phase error that is output during the wobble modulation mark interval constitutes a disturbance for the PLL. That is why to define the loop characteristic that does not respond to that disturbance too sensitively, the current value of the charge pump 133, the resistance and capacitance values of the loop filter 134, and the voltage-frequency response gain of the VCO 135 are determined. When the wobble status becomes the wobble-locked state, the digital phase-locked loop starts to operate on the data signal. And when phase locking is accomplished on the digital data signal after the digital phase-locked loop has started to operate, the interpolated data signal shown in portion (d) of FIG. 14 is divided into multiple values including the zero cross point.

When the ADIP reading section 107 fixes a synchronous position with respect to the ADIP with the wobble-locked state maintained, the wobble status shown in portion (b) of FIG. 14 turns into wobble-locked and ADIP-synchronized state. And in the interval in which the wobble modulation marks are arranged, the wobble phase error gain shown in portion (f) of FIG. 14 is turned OFF. As a result, the frequency of the clock signal shown in portion (g) of FIG. 14 can be controlled with good stability without being affected by the wobble modulation marks.

FIG. 15 is a timing diagram showing how the clock signal generator operates in a situation where the wobble phase error has increased and in a situation where the data phase error has increased. Specifically, portion (a) of FIG. 15 shows the wobble phase error, portion (b) of FIG. 15 shows the data phase error, portion (c) of FIG. 15 shows the respective gains of the wobble and data phase errors, and portion (d) of FIG. 15 shows the frequency of the clock signal.

If the wobble phase error shown in portion (a) of FIG. 15 continues to be a major one, it is determined that the variation in the frequency of the clock signal (see portion (d) of FIG. 15) due to the data phase error is affecting the synchronous state with the wobble signal, and the data phase error gain is decreased to L level as shown in portion (c) of FIG. 15. As a result, the control is now dominated by the wobble phase error, which gradually converges toward zero and comes to have a constant value.

On the other hand, if the data phase error shown in portion (b) of FIG. 15 continues to be a major one, it is determined that the frequency of the clock signal is not controlled sufficiently with respect to the data phase error and the data phase error gain is increased to H level as shown in portion (c) of FIG. 15. As a result, the control is now focused mostly on the data phase error, which gradually converges toward zero and comes to have a constant value.

FIG. 16 is a timing diagram showing how the clock signal generator operates in a situation where the wobble signal has decreased its amplitude and in a situation where the data signal has decreased its amplitude. Specifically, portion (a) of FIG. 16 shows the digital wobble signal. Portion (b) of FIG. 16 shows the value of the wobble amplitude that has been detected by the amplitude detecting section 122. Portion (c) of FIG. 16 shows the wobble phase error. Portion (d) of FIG. 16 shows the digital data signal. Portion (e) of FIG. 16 shows the value of the data amplitude that has been detected by the amplitude detecting section 131. Portion (f) of FIG. 16 shows the data phase error. Portion (g) of FIG. 16 shows the respective gains of the wobble and data phase errors. And portion (h) of FIG. 16 shows the frequency of the clock signal.

If the amplitude of the digital wobble signal shown in portion (a) of FIG. 16 has decreased to the point that the wobble amplitude detected value shown in portion (b) of FIG. 16 becomes smaller than the predetermined threshold value, it is determined that the wobble signal has insufficient amplitude. Since the wobble phase error shown in portion (c) of FIG. 16 does not have a normal value in such a situation, the wobble phase error gain shown in portion (g) of FIG. 16 is turned OFF and the frequency of the clock signal shown in portion (h) of FIG. 16 is controlled with only the data phase error shown in portion (f) of FIG. 16.

On the other hand, if the amplitude of the digital data signal has decreased to the point that the data amplitude detected value shown in portion (e) of FIG. 16 becomes smaller than the predetermined threshold value, it is determined that the data signal has insufficient amplitude. Since the data phase error shown in portion (f) of FIG. 16 does not have a normal value in such a situation, the data phase error gain shown in portion (g) of FIG. 16 is turned OFF and the frequency of the clock signal shown in portion (h) of FIG. 16 is controlled with only the wobble phase error shown in portion (c) of FIG. 16.

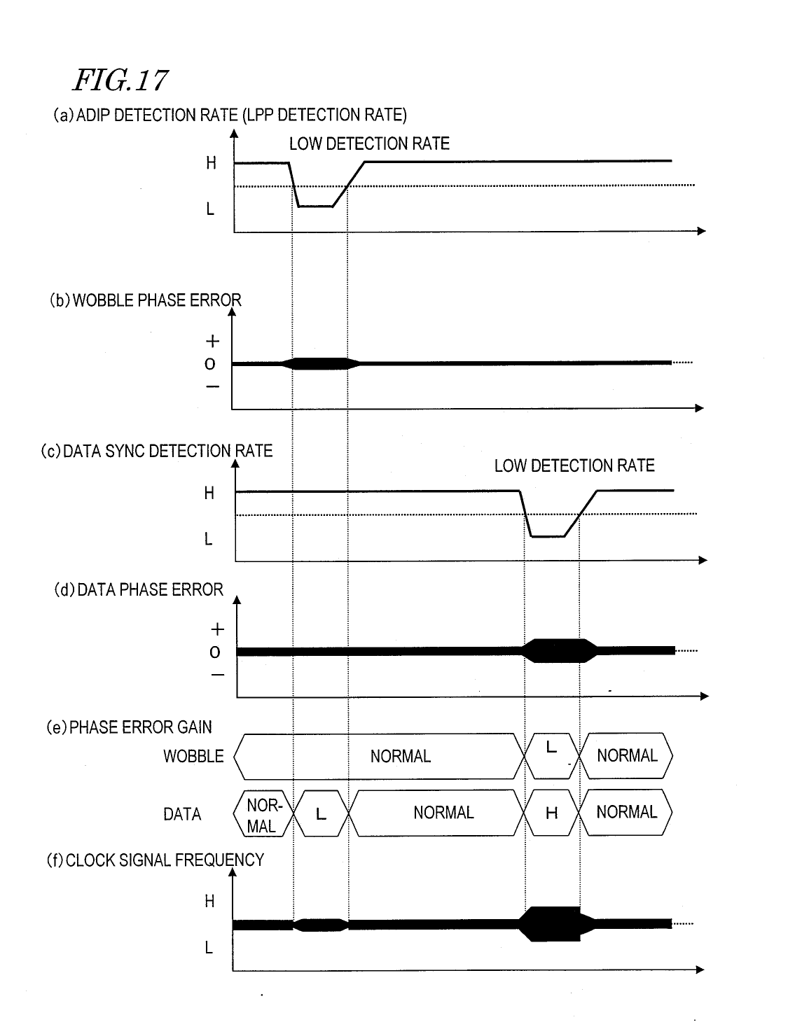

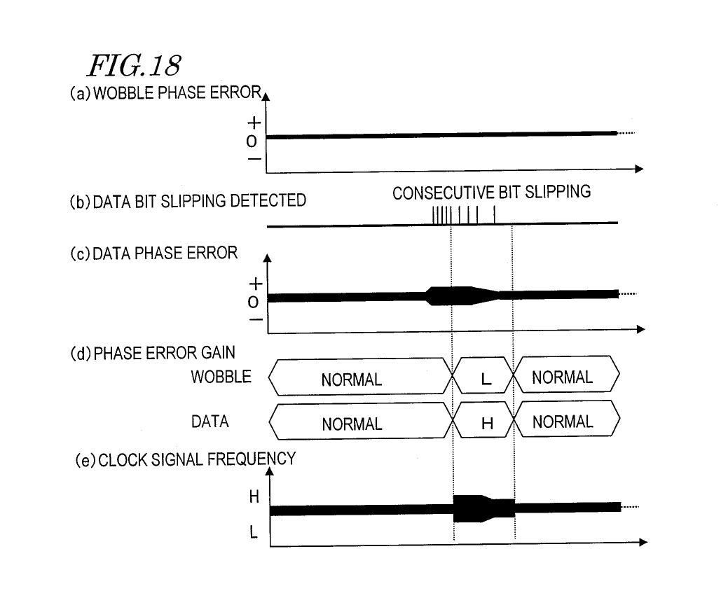

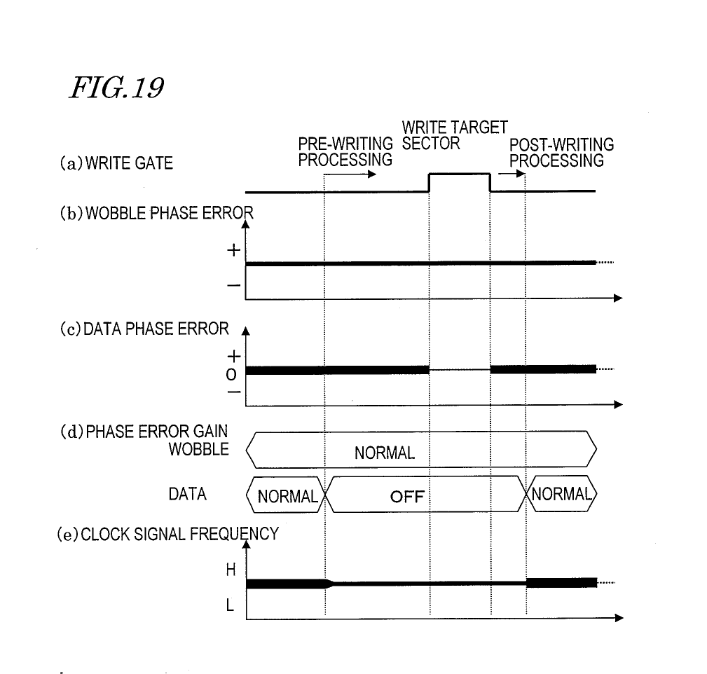

FIG. 17 is a timing diagram showing how the clock signal generator operates in a situation where the ADIP reading section 107 has a low ADIP detection rate and in a situation where the data demodulating section 111 has a low data SYNC detection rate. Specifically, portion (a) of FIG. 17 shows the ADIP detection rate by the ADIP reading section 107 (where the LPP detection rate will be described later). Portion (b) of FIG. 17 shows the wobble phase error. Portion (c) of FIG. 17 shows the data SYNC detection rate by the data demodulating section 111. Portion (d) of FIG. 17 shows the data phase error. Portion (e) of FIG. 17 shows the respective gains of the wobble and data phase errors. And portion (f) of FIG. 17 shows the frequency of the clock signal.

If the ADIP detection rate shown in portion (a) of FIG. 17 becomes smaller than the predetermined threshold value, it is determined that the ADIP detection rate is low due to insufficient control over the wobble phase error shown in portion (b) of FIG. 17. Thus, to recover a sufficient ADIP detection rate shown in portion (a) of FIG. 17, the data phase error gain shown in portion (e) of FIG. 17 is decreased to L level and control is focused mostly on the wobble phase error shown in portion (b) of FIG. 17. When the ADIP detection rate has recovered to exceed the predetermined threshold value as a result, the data phase error gain will be reset to its normal level again.

On the other hand, if the data SYNC detection rate shown in portion (c) of FIG. 17 becomes smaller than the predetermined threshold value, it is determined that the data SYNC detection rate is low due to insufficient control over the data phase error shown in portion (d) of FIG. 17. Thus, to recover a sufficient data SYNC detection rate shown in portion (c) of FIG. 17, the wobble phase error gain shown in portion (e) of FIG. 17 is decreased to L level, the data phase error gain is increased to H level and control is focused mostly on the data phase error. When the data SYNC detection rate has recovered to exceed the predetermined threshold value as a result, the wobble and data phase error gains will be reset to their normal levels again.

FIG. 18 is a timing diagram showing how the clock signal generator operates in a situation where the data demodulating section 111 has detected bit slipping consecutively. Specifically, portion (a) of FIG. 18 shows the wobble phase error. Portion (b) of FIG. 18 shows a data bit slipping detection signal to be output when the data demodulating section 111 detects slipping in data SYNC detection interval. Portion (c) of FIG. 18 shows the data phase error. Portion (d) of FIG. 18 shows the respective gains of the wobble and data phase errors. And portion (e) of FIG. 18 shows the frequency of the clock signal.

If the digital phase-locked loop that has worked on the data signal has lost its stability of operation so much that the data demodulating section 111 detects slipping in data SYNC interval consecutively as represented by the data bit slipping detection signal shown in portion (b) of FIG. 18, it is determined that data bit slipping has occurred due to insufficient control over the data phase error. Thus, to recover the stability of operation of the digital phase-locked loop on the data phase error shown in portion (c) of FIG. 18 and the consistency of the clock signal frequency shown in portion (e) of FIG. 18, the wobble phase error gain shown in portion (d) of FIG. 18 is decreased to L level, the data phase error gain is increased to H level and control is focused mostly on the data phase error. When the data bit slipping detection signal is no longer output consecutively as a result, the wobble and data phase error gains will be reset to their normal levels again.

FIG. 19 is a timing diagram showing how the clock signal generator operates while writing data. Specifically, portion (a) of FIG. 19 shows a write gate signal that is output by the read/write access control section 108 to show the location of a write target sector. Portion (b) of FIG. 19 shows the wobble phase error. Portion (c) of FIG. 19 shows the data phase error. Portion (d) of FIG. 19 shows the respective gains of the wobble and data phase errors. And portion (e) of FIG. 19 shows the frequency of the clock signal.

When the read/write access control section 108 instructs that a write operation be started, the data phase error gain is turned OFF with the wobble phase error gain shown in portion (d) of FIG. 19 maintained at its normal level to generate a clock signal with more stability using only the wobble phase error shown in portion (b) of FIG. 19. In the interval in which the write gate signal shown in portion (a) of FIG. 19 is output, data is written on the optical disk medium 100. When the data has been written, the data phase error gain will be reset to its normal level.

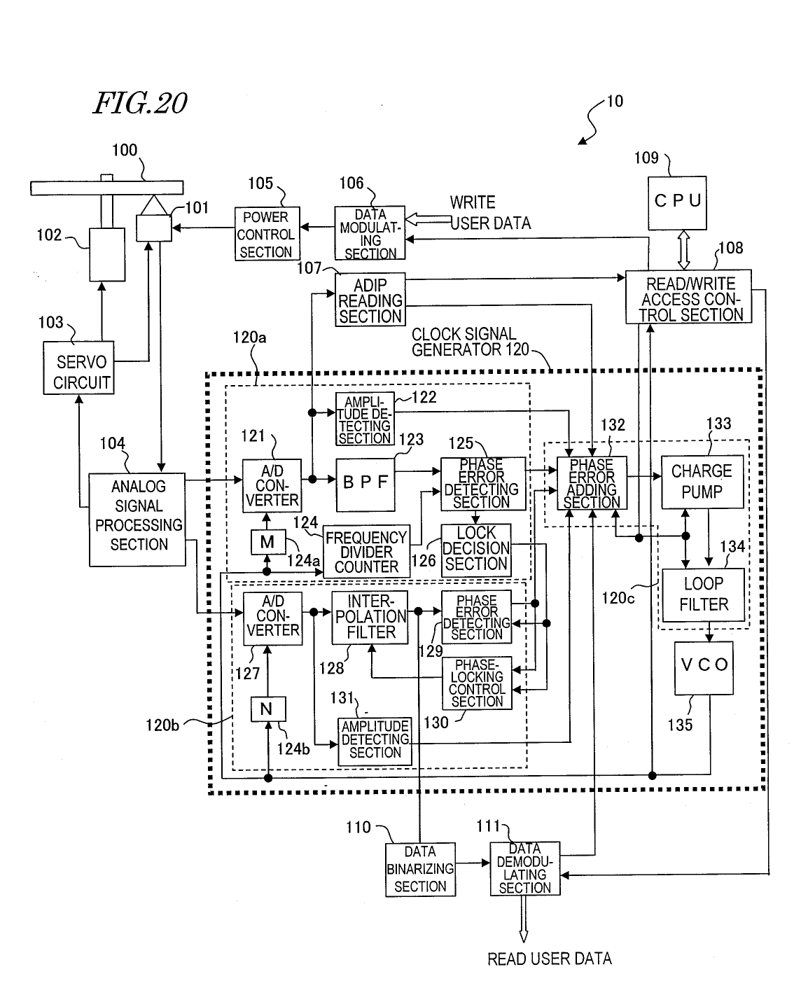

Hereinafter, an optical disk drive 10 that can further cut down power dissipation will be described with reference to FIG. 20, which shows the optical disk drive 10, of which the wobble phase error detecting section 120 includes a divide-by-M counter 124a and the data phase error detecting section 120b includes a divide-by-N counter 124b.

The divide-by-M counter 124a outputs a divide-by-M clock signal that has been obtained by dividing the frequency of the clock signal by M (where M is an integer that is equal to or greater than one). The A/D converter 121 samples the wobble signal in response to the divide-by-M clock signal, thereby outputting a digital wobble signal corresponding to the wobble signal. The phase error detecting section 125 detects a wobble phase error from the digital wobble signal by way of the BPF 123.

The divide-by-N counter 124b outputs a divide-by-N clock signal that has been obtained by dividing the frequency of the clock signal by N (where N is an integer that is equal to or greater than one). The A/D converter 127 samples the data signal in response to the divide-by-N clock signal, thereby outputting a digital data signal corresponding to the data signal. The phase error detecting section 129 detects a data phase error from the digital data signal by way of the interpolation filter.

M and N need to satisfy M≧N. Since the wobble signal has a lower frequency than the data signal, the wobble signal can be sampled sufficiently even in longer sampling periods. By extending the sampling period, the power dissipation by the clock signal generator 120 can be further cut down.

As described above, according to this preferred embodiment, when data is read or written from/on an optical disk medium including a track with ADIP that is based on the MSK modulation, the same VCO generates a clock signal for use in reading and a clock signal for use in writing, thus realizing inexpensive optical disk drive and clock signal generator that dissipate much less power.

In addition, since a fewer types of clock signals are used in an LSI including the clock signal generator of the present invention, the LSI can have a simplified configuration.

Besides, by controlling the gains of the wobble and data phase errors according to the states of the wobble and data signals being read, data can be read and written with the ADIP read with stability.

### Embodiment 2

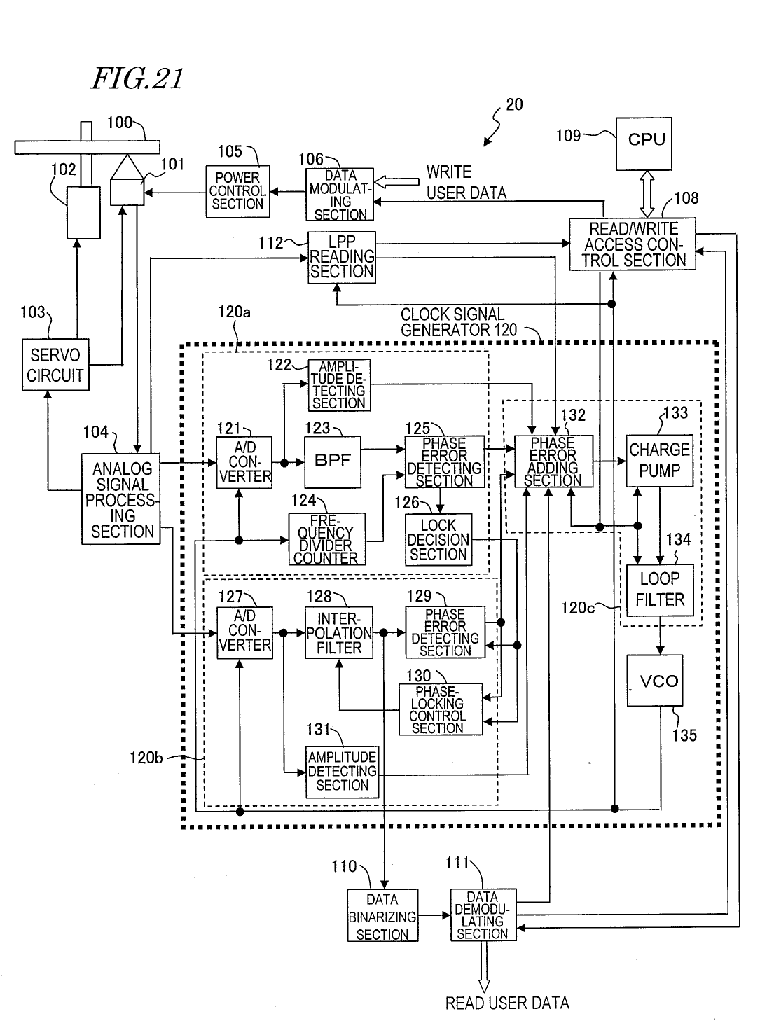

FIG. 21 is a block diagram showing an optical disk drive 20 according to a second specific preferred embodiment of the present invention.

The optical disk drive 20 includes the optical head section 101, the motor 102, the servo circuit 103, the analog signal processing section 104, the power control section 105, the data modulating section 106, an LPP reading section 112, the read/write access control section 108, the CPU 109, the data binarizing section 110, the data demodulating section 111 and the clock signal generator 120. That is to say, the optical disk drive 20 includes the LPP reading section 112 in place of the ADIP reading section 107 of the optical disk drive 10.

The optical disk medium 100 has a track, which is wobbled in a predetermined period and on which information has been written in a predetermined data format. In addition, to write information at predetermined locations on the storage layer of the optical disk medium 100, LPPs (land prepits) representing addresses have also been written in advance between the track grooves (i.e., on the lands) so as to have a predetermined phase relation with respect to wobbling of the track. Data is written in the data format shown in FIG. 3(b) in accordance with the address information represented by the LPPs. The user data to be written is modulated by a predetermined modulation method so as to form sectors and is written on the optical disk medium 100 on a 16 sector basis. Unlike the data format shown in FIG. 3(a), no buffer areas are provided between the end position of the data that is already stored there and the start position of the data to be newly written right after that. That is why in newly writing data, linking writing should be carried out right after the sector position of the previous data that has already been written there.

LPPs are superposed on the wobble components of the electrical signal to be output from the optical head section 101 and are compared to a predetermined threshold value signal at the analog signal processing section 104 so as to be detected as an LPP signal.

The LPP reading section 112 detects synchronous positions with respect to the LPPs based on the LPP signal, thereby reading the address information.

The read/write access control section 108 controls the timing to write data on the optical disk medium 100 based on the address information that has been read by the LPP reading section 112 and on the LPP synchronous positions. Also, based on the address information and the data SYNC positions included in the data that has been read by the data demodulating section 111, the read/write access control section 108 controls the timings to perform linking writing of data on the optical disk medium 100 and the timing to read data.

The phase error adding section 132 calculates the sum of the wobble and data phase errors while controlling their ratio and outputs an UP pulse signal to increase the frequency of the clock signal or a DOWN pulse signal to decrease it.

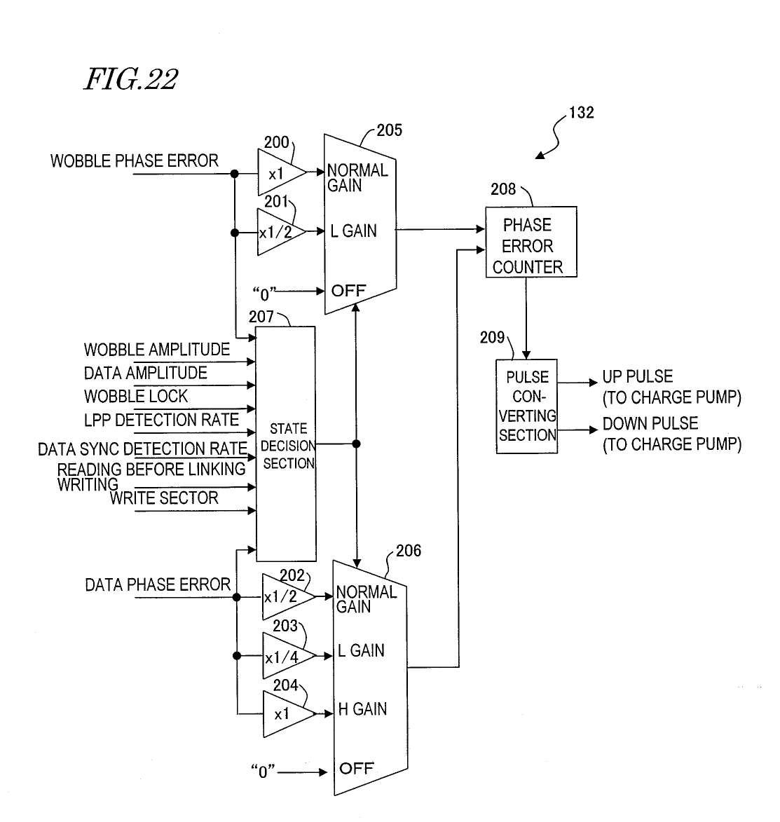

FIG. 22 is a block diagram showing the phase error adding section 132 of this preferred embodiment, which includes multipliers 200 to 204, a wobble gain selector 205 for changing the ratios of the wobble phase error, a data gain selector 206 for changing the ratios of the data phase error, a state decision section 207 for determining the logic of selection between the wobble gain selector 205 and the data gain selector 206, a phase error counter 208 that operates while adding together the wobble and data phase errors that have had their gains controlled, and a pulse converting section 209 for selectively outputting an UP pulse signal or a DOWN pulse signal according to the count of the phase error counter 208.

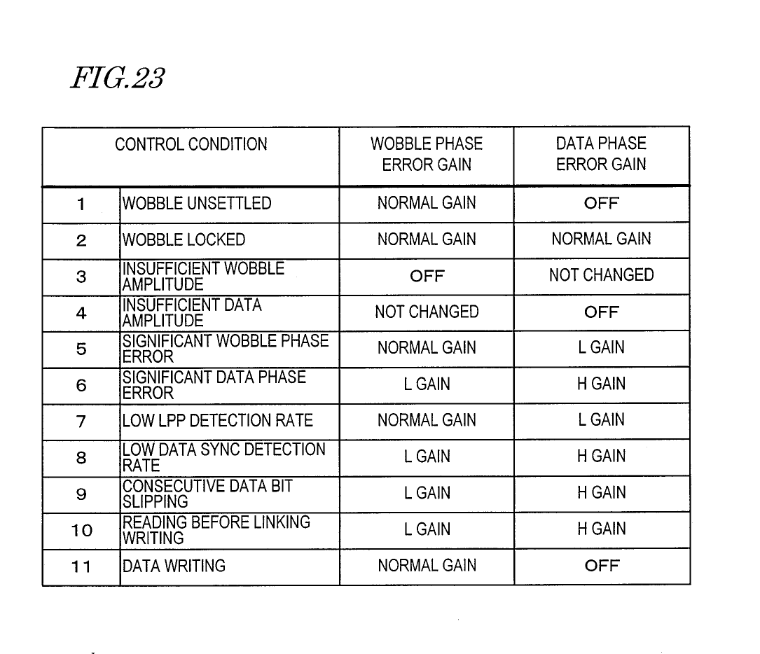

FIG. 23 is a table showing the logic with which the state decision section 207 switches the wobble phase error gain and the data phase error gain.

If the wobble lock signal indicates that the phase of the wobble signal has not been locked to that of the clock signal yet, the phase error adding section 132 is in the “wobble unsettled” state (which is control condition (1)). In that state, the wobble phase error gain is a normal gain (e.g., 1×), the data phase error gain is turned OFF, the frequency of the clock signal is controlled with only the wobble phase error, and the best condition is established for the wobble signal. On the other hand, if the wobble lock signal indicates that phase locking has been accomplished, the “wobble locked” state (which is control condition (2)) is established. In that state, the wobble phase error is a normal gain, so is the data phase error gain (e.g., ½×), the frequency of the clock signal is controlled with both the wobble phase error and the data phase error, and both the wobble signal and the data signal can be read at the same time.

If the wobble amplitude value supplied from the amplitude detecting section 122 is smaller than a predetermined threshold value, the phase error adding section 132 determines that the wobble signal is not read normally, thus determining that this is “insufficient wobble amplitude” state (which is control condition (3)). In that state, the wobble phase error gain is turned OFF but the data phase error gain is not changed but stays put. As a result, in an area of the optical disk medium 100 where the wobble signal cannot have its normal amplitude due to the presence of a scratch or finger mark on the track, the wobble signal has low reliability, and therefore, the wobble phase error is not used to control the frequency of the clock signal.

Also, if the data amplitude value supplied from the amplitude detecting section 131 is smaller than a predetermined threshold value, the phase error adding section 132 determines that the data signal is not read normally, thus determining that this is “insufficient data amplitude” state (which is control condition (4)). In that state, the data phase error gain is turned OFF but the wobble phase error gain is not changed but stays put. As a result, in an area of the optical disk medium 100 where the data signal cannot have its normal amplitude due to the presence of a scratch or finger mark on the track or in an area where data has not been written properly due to insufficient power of the light beam that was used to write the data, the data signal has low reliability, and therefore, the data phase error is not used to control the frequency of the clock signal.

If the absolute value of the wobble phase error supplied from the phase error detecting section 125 continues to be greater than a predetermined threshold value all through a prescribed period, the phase error adding section 132 determines that control over the wobble signal has loosened, thus determining that this is “significant wobble phase error” state (which is control condition (5)). In that state, the wobble phase error gain is supposed to be a normal gain but the data phase error gain is supposed to be an L gain (e.g., ¼×). As a result, when the frequency of the clock signal is controlled, the control is much less affected by the data phase error but is now affected more significantly by the wobble phase error, thus tightening the control over the wobble signal.

On the other hand, if the absolute value of the data phase error supplied from the phase error detecting section 129 continues to be greater than a predetermined threshold value all through a prescribed period, the phase error adding section 132 determines that control over the data signal has loosened, thus determining that this is “significant data phase error” state (which is control condition (6)). In that state, the wobble phase error gain is supposed to be an L gain (e.g., ½×) and the data phase error gain is supposed to be an H gain (e.g., 1×). As a result, when the frequency of the clock signal is controlled, the control is much less affected by the wobble phase error but is now affected more significantly by the data phase error, thus tightening the control over the data signal.

If the LPP detection rate supplied from the LPP reading section 112 continues to be lower than a predetermined threshold value all through a prescribed period, the phase error adding section 132 determines that control over the wobble signal has loosened and is now affecting LPP reading, thus determining that this is “low LPP detection rate” state (which is control condition (7)). In that state, the wobble phase error gain is supposed to be a normal gain and the data phase error gain is supposed to be an L gain. As a result, when the frequency of the clock signal is controlled, the control is much less affected by the data phase error but is now affected more significantly by the wobble phase error, thus tightening the control over the wobble signal and increasing the LPP detection rate.

The data demodulating section 111 detects data SYNC marks that are arranged in a predetermined modulation format at regular intervals from the binarized data signal and provides the detection rate (i.e., data SYNC detection rate) for the phase error adding section 132. If the data SYNC detection rate continues to be lower than a predetermined threshold value all through a prescribed period, the phase error adding section 132 determines that control over the data signal has loosened and is now affecting data reading, thus determining that this is “low data SYNC detection rate” state (which is control condition (8)). In that state, the wobble phase error gain is supposed to be an L gain but the data phase error gain is supposed to be an H gain. As a result, when the frequency of the clock signal is controlled, the control is much less affected by the wobble phase error but is now affected more significantly by the data phase error, thus tightening the control over the data signal and increasing the data SYNC detection rate.

Also, the data demodulating section 111 determines, by the data SYNC detection interval, whether or not bit slipping has occurred in the binarized data signal. If bit slipping has occurred a predetermined number of times in a row, the phase error adding section 132 determines that control over the data signal has loosened and is now affecting data reading, thus determining that this is “consecutive data bit slipping” state (which is control condition (9)). In that state, the wobble phase error gain is supposed to be an L gain but the data phase error gain is supposed to be an H gain. As a result, when the frequency of the clock signal is controlled, the control is much less affected by the wobble phase error but is now affected more significantly by the data phase error, thus tightening the control over the data signal and reducing the occurrence of bit slipping.

A timing signal, indicating that the current location being processed is one of a read sector, a sector right before the linking writing target and a write sector, is supplied from the read/write access control section 108 to the phase error adding section 132. If it is a read sector, the phase error adding section 132 operates under the control conditions (1) through (9) described above. On the other hand, if it is a sector right before the linking writing target, “reading right before linking writing” state, which is control condition (10), is entered. And if it is a write sector, “data writing” state, which is control condition (11), is entered.

If linking writing is performed in sync with the data that has already been written on the optical disk medium 100, the phase error adding section 132 sets the ratio of the data phase error to be higher than that of the wobble phase error until writing is started but sets the ratio of the data phase error to be lower than that of the wobble phase error once writing has been started. In the “reading right before linking writing” state, the wobble and data phase errors are supposed to have L gain and H gain, respectively, thereby controlling the frequency of the clock signal mainly based on the data signal such that the beginning of the data to be newly written has a continuous phase with the previous data that has already been written. And in the “data writing” state, the wobble phase error gain is supposed to be a normal gain and the data phase error gain is turned OFF, thereby controlling the frequency of the clock signal with only the wobble signal and writing data synchronously with wobbling of the track.

Next, it will be described with reference to FIGS. 24, 25 and 17 how the clock signal generator with such a configuration operates.

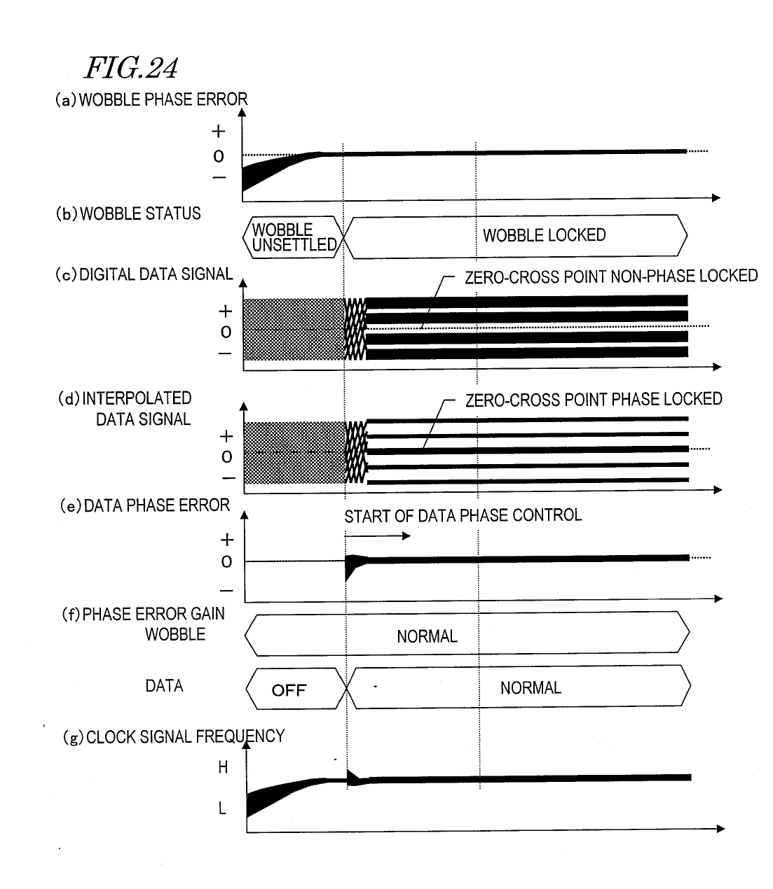

FIG. 24 is a timing diagram showing how the clock signal generator operates in the wobble unsettled state and the wobble locked state. Specifically, portion (a) of FIG. 24 shows the wobble phase error detected by the phase error detecting section 125. Portion (b) of FIG. 24 shows wobble statuses representing the degrees of locking of the PLL that have been determined by the lock decision section 126. Portion (c) of FIG. 24 shows the digital data signal generated by the A/D converter 127. Portion (d) of FIG. 24 shows the interpolated data signal generated by the interpolation filter 128. Portion (e) of FIG. 24 shows the data phase error detected by the phase error detecting section 129. Portion (f) of FIG. 24 shows the respective gains of the wobble and data phase errors at the phase error adding section 132. And portion (g) of FIG. 24 shows the frequency of the clock signal generated by the VCO 135.

At the start point of the operation, the wobble status shown in portion (b) of FIG. 24 is the wobble unsettled state, and the negative wobble phase error value shown in portion (a) of FIG. 24 indicates that the clock signal has a phase lag. In such a state, the phase error gains shown in portion (f) of FIG. 24 include a data phase error gain in OFF state and a wobble phase error gain that is a normal gain. As a result, the frequency of the clock signal shown in portion (g) of FIG. 24 is controlled so as to increase gradually with the wobble phase error.

When the phase of the wobble signal substantially agrees with that of the clock signal, the wobble phase error shown in portion (a) of FIG. 24 becomes approximately equal to zero. And when the lock decision section 126 detects that state, the wobble status shown in portion (b) of FIG. 24 turns into the wobble locked state. When the wobble status becomes the wobble-locked state, the digital phase-locked loop starts to operate on the data signal. And when phase locking is accomplished on the digital data signal after the digital phase-locked loop has started to operate, the interpolated data signal shown in portion (d) of FIG. 24 is divided into multiple values including the zero cross point.

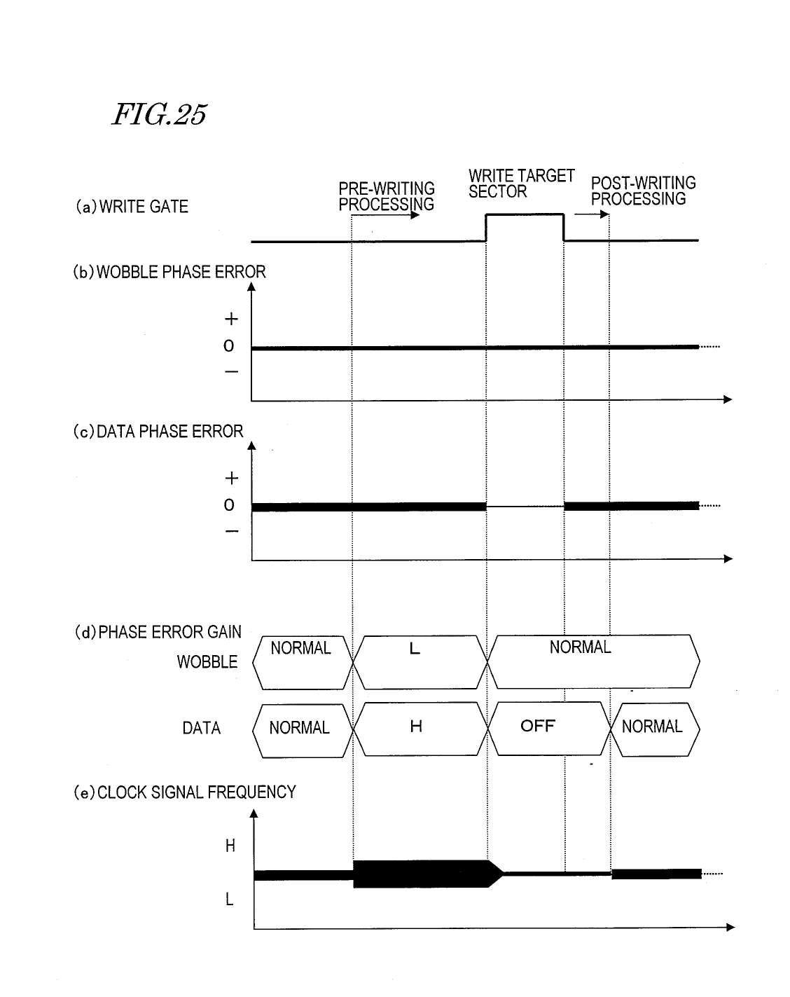

FIG. 25 is a timing diagram showing how the clock signal generator operates in the reading right before linking writing state and in the data writing state. Specifically, portion (a) of FIG. 25 shows a write gate signal that is output by the read/write access control section 108 to show the location of a write target sector. Portion (b) of FIG. 25 shows the wobble phase error. Portion (c) of FIG. 25 shows the data phase error. Portion (d) of FIG. 25 shows the respective gains of the wobble and data phase errors. And portion (e) of FIG. 25 shows the frequency of the clock signal.

When the read/write access control section 108 instructs that linking writing be started, the wobble phase error gain shown in portion (d) of FIG. 25 is decreased to L level, the data phase error gain is increased to H level and the clock signal frequency shown in portion (e) of FIG. 25 is controlled using mainly the data phase error shown in portion (c) of FIG. 25 to generate a clock signal synchronized with the data. When the write gate signal shown in portion (a) of FIG. 25 is output to reach the writing target sector, the wobble phase error gain is supposed to be a normal gain and the data phase error gain is turned OFF to generate a clock signal consistently with only the wobble phase error shown in portion (b) of FIG. 25. And in the interval in which the write gate signal is output, data is written on the optical disk medium 100. When the data has been written, the data phase error gain will be reset to its normal level.

FIG. 17 is a timing diagram showing how the clock signal generator operates in a situation where the LPP reading section 112 has a low LPP detection rate and in a situation where the data demodulating section 111 has a low data SYNC detection rate. Specifically, portion (a) of FIG. 17 shows the LPP detection rate by the LPP reading section 112. Portion (b) of FIG. 17 shows the wobble phase error. Portion (c) of FIG. 17 shows the data SYNC detection rate by the data demodulating section 111. Portion (d) of FIG. 17 shows the data phase error. Portion (e) of FIG. 17 shows the respective gains of the wobble and data phase errors. And portion (f) of FIG. 17 shows the frequency of the clock signal.

If the LPP detection rate shown in portion (a) of FIG. 17 becomes smaller than the predetermined threshold value, it is determined that the LPP detection rate is low due to insufficient control over the wobble phase error shown in portion (b) of FIG. 17. Thus, to recover a sufficient LPP detection rate, the data phase error gain shown in portion (e) of FIG. 17 is decreased to L level and control is focused mostly on the wobble phase error. When the LPP detection rate has recovered to exceed the predetermined threshold value as a result, the data phase error gain will be reset to its normal level again.

On the other hand, if the data SYNC detection rate shown in portion (c) of FIG. 17 becomes smaller than the predetermined threshold value, it is determined that the data SYNC detection rate is low due to insufficient control over the data phase error shown in portion (d) of FIG. 17. Thus, to recover a sufficient data SYNC detection rate, the wobble phase error gain shown in portion (e) of FIG. 17 is decreased to L level, the data phase error gain is increased to H level and control is focused mostly on the data phase error. When the data SYNC detection rate has recovered to exceed the predetermined threshold value as a result, the wobble and data phase error gains will be reset to their normal levels again.

The clock signal generator will operate just as already described for the first preferred embodiment in the “significant wobble phase error” state, “significant data phase error” state, “insufficient wobble amplitude” state, “insufficient data amplitude” state, and “consecutive data bit slipping” state.

As described above, according to the second preferred embodiment, when data is read or written from/on an optical disk medium on which address information has been written as LPPs, the same VCO generates a clock signal for use in reading and a clock signal for use in writing, thus realizing inexpensive optical disk drive and clock signal generator that dissipate much less power.

In addition, since a fewer types of clock signals are used in an LSI including the clock signal generator of the present invention, the LSI can have a simplified configuration.

Besides, by controlling the gains of the wobble and data phase errors according to the states of the wobble and data signals being read, reading and linking writing of data can be performed with the LPPs read constantly.

### Embodiment 3

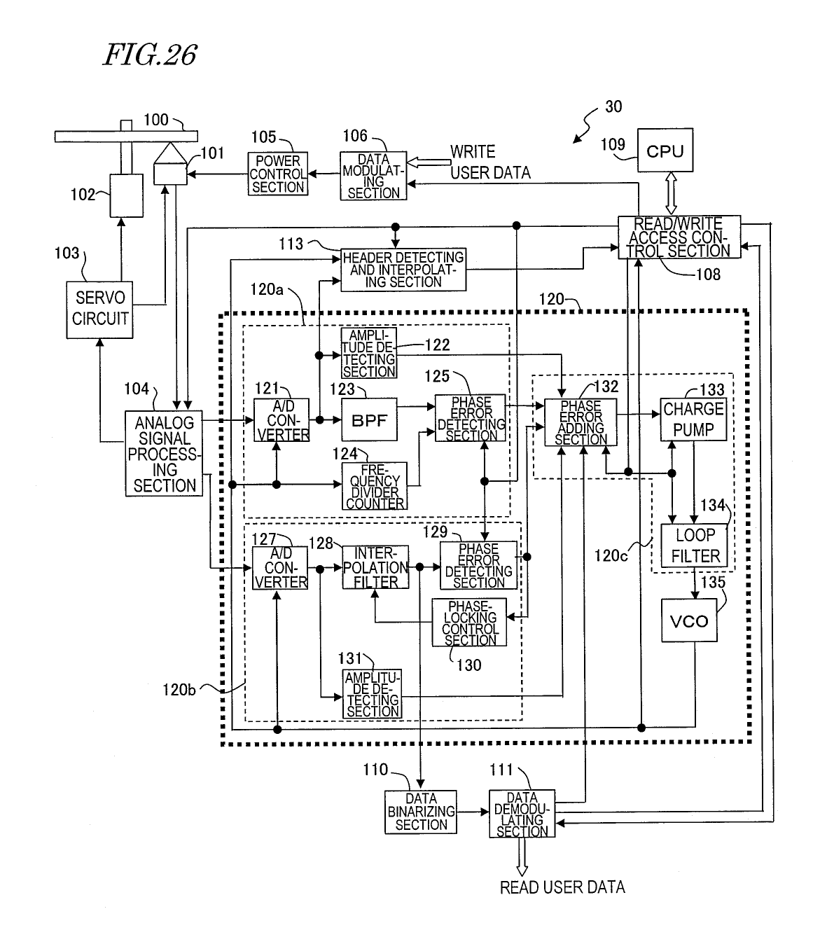

FIG. 26 is a block diagram showing an optical disk drive 30 according to a third specific preferred embodiment of the present invention.

The optical disk drive 30 includes the optical head section 101, the motor 102, the servo circuit 103, the analog signal processing section 104, the power control section 105, the data modulating section 106, a header detecting and interpolating section 113, the read/write access control section 108, the CPU 109, the data binarizing section 110, the data demodulating section 111 and the clock signal generator 120. That is to say, the optical disk drive 30 includes the header detecting and interpolating section 113 in place of the ADIP reading section 107 of the optical disk drive 10. Various signals are input from the read/write access control section 108 to phase error detecting sections 125 and 129.

The track of the optical disk medium 100 has header areas in which address information is stored and data areas in which data is written and which are wobbled in a predetermined period. FIG. 3(c) shows the data format of the optical disk medium 100. The user data to write is modulated by a predetermined modulation method to form data areas of respective sectors and then is written on the optical disk medium 100 on a sector-by-sector basis. In this data format, each sector includes a read-only header area in which address information is stored and the data areas are distributed in respective sectors, unlike the data formats shown in FIGS. 3(a) and 3(b).

In the header area, the track is not wobbled but address information is stored as data, which is detected as high frequency components in an electrical signal to be output from the optical head section 101. The header detecting and interpolating section 113 detects a variation in amplitude in such a frequency range by the digital wobble signal supplied from the A/D converter 121 and notifies the read/write access control section 108 of the header area detection range. Also, the header detecting and interpolating section 113 measures the frequency of the clock signal in the header area and makes an interpolation to locate the header area of the next sector based on the measured value.

The read/write access control section 108 instructs the data demodulating section 111 to read the address information from the header area, gets the address information, and controls the timing to read and write data from/on the data area on the optical disk medium 100 based on the address information. Also, the read/write access control section 108 outputs a timing signal showing the location of the header area in the next sector to the analog signal processing section 104, the header detecting and interpolating section 113, data demodulating section 106, and clock signal generator 120, thereby controlling these components such that they operate properly in the header area and in the data area.

The header detecting and interpolating section 113 and the read/write access control section 108 also function as a control section for detecting the frequency of the clock signal while the header area is being accessed, estimating the length of the data area that follows the header area based on the frequency detected, and locating the next header area.

The phase error adding section 132 adds together the wobble phase error and data phase error with the ratios of these two phase errors controlled. Based on the sum, the phase error adding section 132 outputs either an UP pulse signal to increase the frequency of the clock signal or a DOWN pulse signal to decrease the frequency of the clock signal.

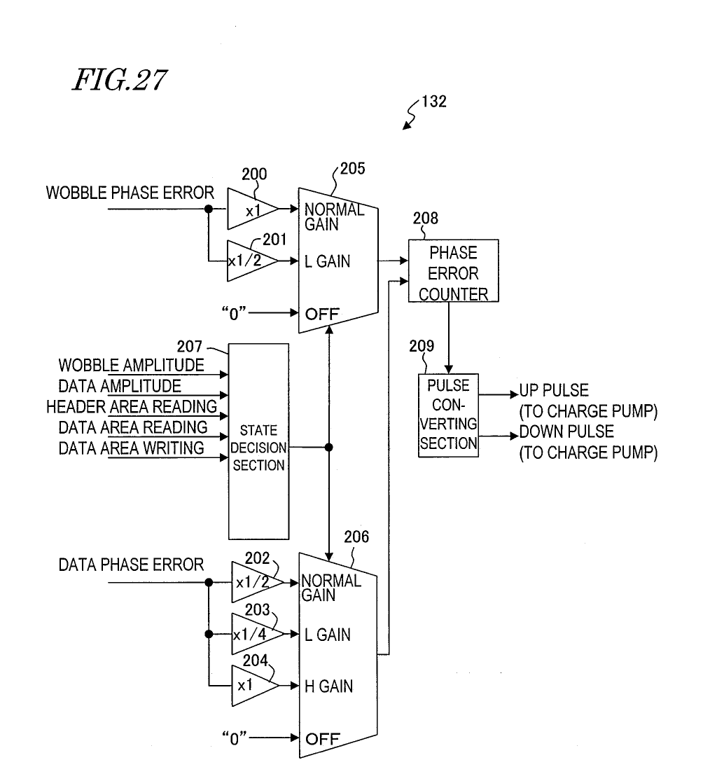

FIG. 27 is a block diagram showing the phase error adding section 132 of this preferred embodiment, which includes multipliers 200 to 204, a wobble gain selector 205 for changing the ratios of the wobble phase error, a data gain selector 206 for changing the ratios of the data phase error, a state decision section 207 for determining the logic of selection between the wobble gain selector 205 and the data gain selector 206, a phase error counter 208 that operates while adding together the wobble and data phase errors that have had their gains controlled, and a pulse converting section 209 for selectively outputting an UP pulse signal or a DOWN pulse signal according to the count of the phase error counter 208.

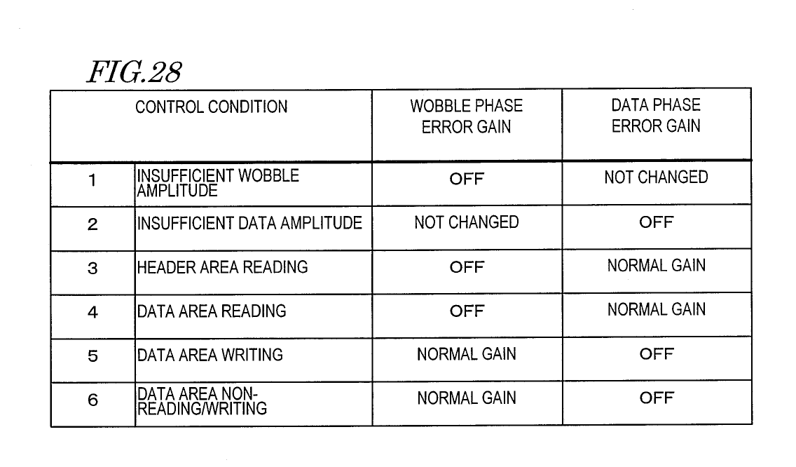

FIG. 28 is a table showing the logic with which the state decision section 207 switches the wobble phase error gain and the data phase error gain.

In reading address information and data from the header area and from the data area, respectively, the phase error adding section 132 sets the ratio of the wobble phase error to be lower than that of the data phase error. But in writing data on the data area, the phase error adding section 132 sets the ratio of the data phase error to be lower than that of the wobble phase error.

In processing the data area, if the wobble amplitude value supplied from the wobble signal amplitude detecting section 122 is smaller than a predetermined threshold value, the phase error adding section 132 determines that the wobble signal is not read normally, thus determining that this is “insufficient wobble amplitude” state (which is control condition (1)). In that state, the wobble phase error gain is turned OFF but the data phase error gain is not changed but stays put. As a result, in an area of the optical disk medium 100 where the wobble signal cannot have its normal amplitude due to the presence of a scratch or finger mark on the track, the wobble signal has low reliability, and therefore, the wobble phase error is not used to control the frequency of the clock signal.

Also, if the data amplitude value supplied from the data signal amplitude detecting section 131 is smaller than a predetermined threshold value, the phase error adding section 132 determines that the data signal is not read normally, thus determining that this is “insufficient data amplitude” state (which is control condition (2)). In that state, the data phase error gain is turned OFF but the wobble phase error gain is not changed but stays put. As a result, in an area of the optical disk medium 100 where the data signal cannot have its normal amplitude due to the presence of a scratch or finger mark on the track or in an area where data has not been written properly due to insufficient power of the light beam that was used to write the data, the data signal has low reliability, and therefore, the data phase error is not used to control the frequency of the clock signal.

If the read/write access control section 108 has instructed the phase error adding section 132 to read address information from the header area, then the phase error adding section 132 is in the “header area reading” state, which is control condition (3). In the header area, the track is not wobbled but data representing the address information is stored. That is why the wobble phase error gain is turned OFF, the data phase error gain is supposed to be a normal gain, and control is performed with only the data phase error.

On the other hand, if the read/write access control section 108 has instructed the phase error adding section 132 to read data from the data area, then the phase error adding section 132 is in the “data area reading” state, which is control condition (4). In the data area, the track is wobbled but just data needs to be read as properly as possible. That is why the wobble phase error gain is turned OFF, the data phase error gain is supposed to be a normal gain, and control is performed with only the data phase error.

Furthermore, if the read/write access control section 108 has instructed the phase error adding section 132 to write data on the data area, then the phase error adding section 132 is in the “data area writing” state, which is control condition (5). To write data synchronously with wobbling of the track, the wobble phase error gain is supposed to be a normal gain, the data phase error gain is turned OFF, and control is performed with only the wobble phase error.

If data is going to be neither read nor written from/on the data area, the phase error adding section 132 needs to make accurate interpolation on the remaining portion of the data area before the header area of the next sector comes up. For that purpose, the wobble phase error gain is supposed to be a normal gain, the data phase error gain is turned OFF, and control is performed with only the wobble phase error.

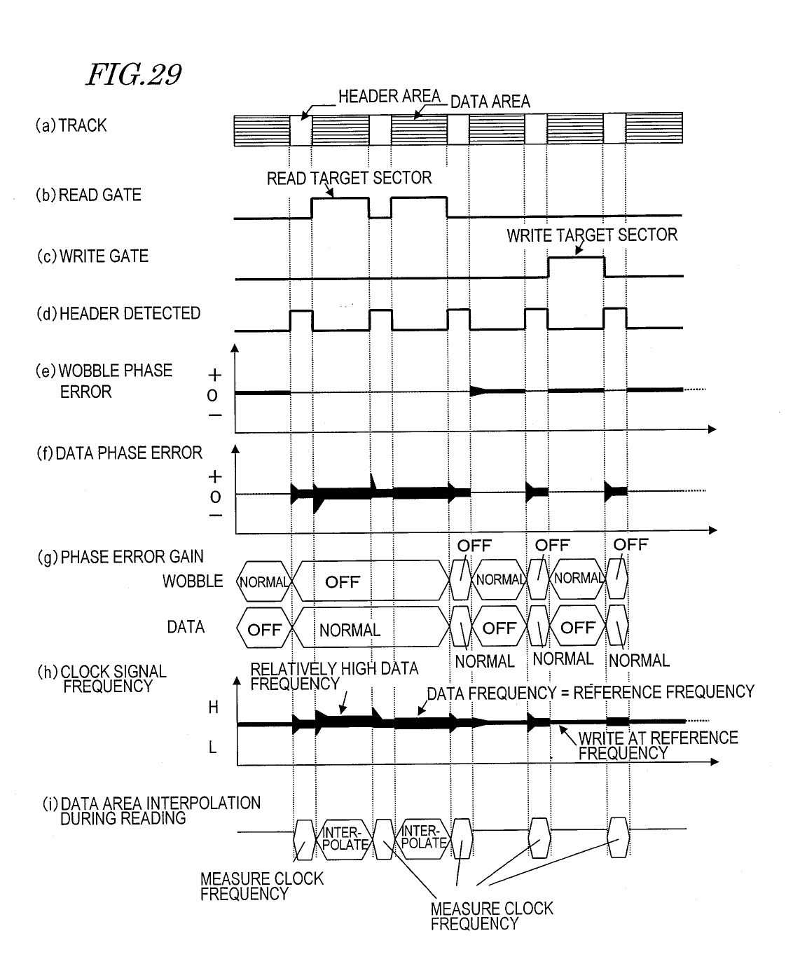

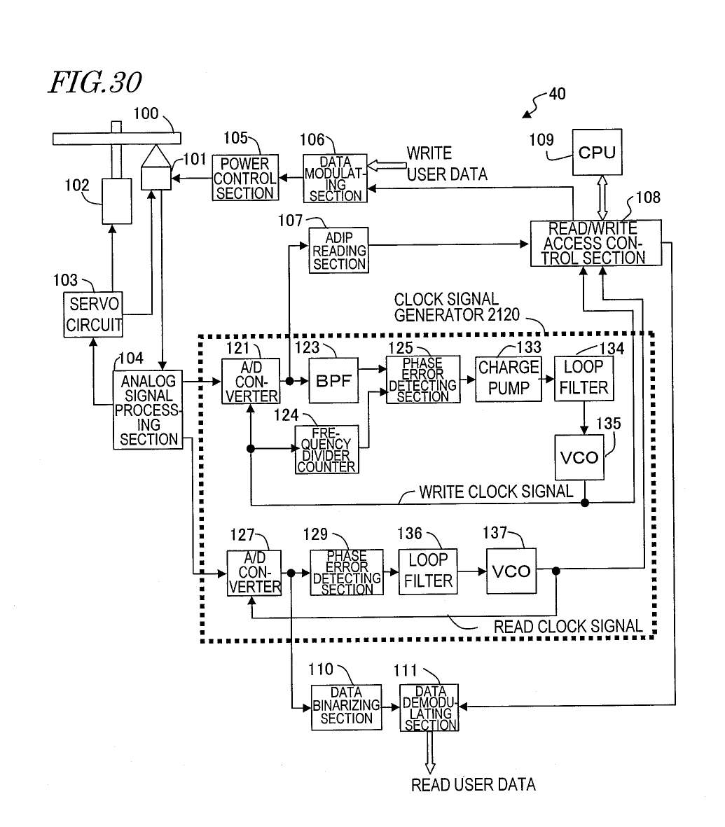

Next, it will be described with reference to FIG. 29 how the clock signal generator 120 of this preferred embodiment operates.

FIG. 29 is a timing diagram showing how the clock signal generator operates in the header area reading state, data area reading state, data area writing state and data area non-reading/writing state. Specifically, portion (a) of FIG. 29 shows a track with header areas and data areas. Portion (b) of FIG. 29 shows a read gate signal instructing that data be read from data areas. Portion (c) of FIG. 29 shows a write gate signal instructing that data be written on a data area. Portion (d) of FIG. 29 shows a header detection signal showing that header areas have been detected. Portion (e) of FIG. 29 shows the wobble phase error. Portion (f) of FIG. 29 shows the data phase error. Portion (g) of FIG. 29 shows the respective gains of the wobble and data phase errors. Portion (h) of FIG. 29 shows the frequency of the clock signal. And portion (i) of FIG. 29 shows how an interpolation operation is performed on the data areas.

In the intervals in which the header detection signal representing the header areas as shown in portion (d) of FIG. 29 is output, the phase error adding section 132 is in the header area reading state, the wobble phase error gain shown in portion (g) of FIG. 29 is turned OFF, and the data phase error gain is a normal one. Also, in each of those header areas, to make an interpolation on the range of the data area that follows and to predict the location of the header area in the next sector, the frequency of the clock signal is measured as shown in portion (i) of FIG. 29 and the data area range is interpolated based on the measured value.

When the read gate signal instructing that data be read as shown in portion (b) of FIG. 29 is output in the data area, the phase error adding section 132 is in the data area reading state, the wobble phase error gain shown in portion (g) of FIG. 29 is turned OFF, and the data phase error gain is a normal one. As a result, even if the channel frequency of the data signal is somewhat higher than the reference frequency (i.e., the frequency of the wobble signal) as shown in portion (h) of FIG. 29, data can be read with no problem because the control is being performed with only the data phase errors shown in portion (f) of FIG. 29.

When the write gate signal instructing that data be written as shown in portion (c) of FIG. 29 is output in the data area, the phase error adding section 132 is in the data area writing state, the wobble phase error gain shown in portion (g) of FIG. 29 is a normal one, and the data phase error gain is turned OFF. As a result, data can be written in sync with wobbling because the clock signal is controlled with only the wobble phase errors shown in portion (e) of FIG. 29.

When neither the read gate signal shown in portion (b) of FIG. 29 nor the write gate signal shown in portion (c) of FIG. 29 is output in the data area, the phase error adding section 132 is in the data area non-reading/writing state, the wobble phase error gain shown in portion (g) of FIG. 29 is a normal one, and the data phase error gain is turned OFF. The channel frequency caused by wobbling of the data areas is the same as that of the data in the header areas. That is why if the data area range is controlled with only the wobble phase error shown in portion (e) of FIG. 29, there will be no frequency error when information starts to be read from the header area of the next sector. As a result, the address information can be read with good stability.

In the insufficient wobble amplitude state and in the insufficient data amplitude state, the clock signal generator operates just as already described for the first preferred embodiment.

As described above, according to the third preferred embodiment, when data is read or written from/on an optical disk medium including a header area on which address information is stored and a data area from/on which data is read and written, the same VCO generates a clock signal for use in reading and a clock signal for use in writing, thus realizing inexpensive optical disk drive and clock signal generator that dissipate much less power.

In addition, since a fewer types of clock signals are used in an LSI including the clock signal generator of the present invention, the LSI can have a simplified configuration.

Besides, by controlling the gains of the wobble and data phase errors according to the states of the wobble and data signals being read and depending on whether it is the header area or the data area, data can be read and written with the header area scanned with stability.

The respective components of the optical disk drive and clock signal generator of the present invention may be implemented by means of hardware and/or software. For example, the clock signal generation processing described above may be implemented using a computer-executable program and a computer in combination.

Also, the clock signal generator of the present invention may be implemented as a semiconductor integrated circuit, a ROM that stores a clock signal generation processing program, a RAM in which the clock signal generation processing program is (pre)installed, a RAM in which a downloaded clock signal generation processing program is installed, or a combination thereof.

The clock signal generator of the present invention may be implemented as an LSI, which is a type of integrated circuit. The components of the clock signal generator may be implemented as respective chips or may also be integrated together into a single chip either fully or just partially.

In the foregoing description, the integrated circuit is called an “LSI”. But the integrated circuit may be called an IC, an LSI, a super LSI or an ultra LSI, depending on the number of devices that are integrated together per unit area.

The integrated circuit does not have to be an LSI but may also be implemented as a dedicated circuit or a general-purpose processor. Optionally, after an LSI has been fabricated, a programmable FPGA (field programmable gate array) or a reconfigurable processor in which the connection or setting of circuit cells inside the LSI are changeable may be adopted.

As another possibility, a novel integrated circuit technology to replace LSIs might be developed in the near future as a result of advancement of the semiconductor technology or any other related technology. In that case, the functional blocks could be integrated together by that novel technology. For example, the functional blocks could be integrated together as bio elements by utilizing some biotechnology.

According to the present invention, the same clock signal is used to read the wobble signal and to read the data signal. As a result, the number of VCOs, which are expensive analog components that dissipate a lot of power, can be reduced while maintaining the ability to read both the wobble signal and the data signal with good stability. In addition, by simplifying the configurations of their associated data reading and writing circuit systems, the cost of the LSI can also be cut down.

### INDUSTRIAL APPLICABILITY

The present invention can be used particularly effectively in the field of technology of reading and writing data using a clock signal.

1. A clock signal generator for generating a clock signal, the generator comprising:
a wobble phase error detecting section for detecting a wobble phase error that is a difference in phase between a wobble signal, which is obtained from a wobbled shape of a track on an optical disk medium, and the clock signal;
a data phase error detecting section for detecting a data phase error that is a difference in phase between a data signal, which is obtained from data that has been written on the optical disk medium, and the clock signal;
a frequency control section for generating a frequency control signal to control the frequency of the clock signal based on the wobble phase error and the data phase error; and
a clock oscillation section for generating the clock signal with its frequency controlled in accordance with the frequency control signal.

2. The clock signal generator of claim 1, wherein the frequency control section generates the frequency control signal based on the sum of the wobble and data phase errors, and
wherein the frequency control section changes the ratios of the wobble and data phase errors being added together according to the states of the wobble and data signals.

3. The clock signal generator of claim 2, wherein the frequency control section changes the ratios according to the qualities of the wobble and data signals.

4. The clock signal generator of claim 2, wherein if the wobble signal has an amplitude that is smaller than a first threshold value, the frequency control section sets the ratio of the wobble phase error to be lower than that of the data phase error, and
wherein if the data signal has an amplitude that is smaller than a second threshold value, the frequency control section sets the ratio of the data phase error to be lower than that of the wobble phase error.

5. The clock signal generator of claim 2, wherein a part of the wobbled shape of the track has been subjected to either a frequency modulation or a phase modulation, and
wherein in an interval in which a wobble signal, which is obtained from the wobbled shape that has been subjected to the frequency modulation or the phase modulation, is detected, the frequency control section sets the ratio of the wobble phase error to be lower than that of the data phase error.

6. The clock signal generator of claim 2, wherein the frequency control section changes the ratios according to the degree to which at least one of the wobble and data signals is synchronized with the clock signal.

7. The clock signal generator of claim 2, wherein if the absolute value of the wobble phase error is greater than a first threshold value, the frequency control section sets the ratio of the wobble phase error to be higher than that of the data phase error, and
wherein if the absolute value of the data phase error is greater than a second threshold value, the frequency control section sets the ratio of the data phase error to be higher than that of the wobble phase error.

8. The clock signal generator of claim 2, wherein unless phase locking is accomplished between the wobble signal and the clock signal, the frequency control section sets the ratio of the data phase error to be lower than that of the wobble phase error, and
wherein once phase locking has been accomplished, the frequency control section increases the ratio of the data phase error compared to the situation where the phase locking has not been accomplished yet.

9. The clock signal generator of claim 2, wherein a portion of the wobbled shape of the track has been subjected to either a frequency modulation or a phase modulation, and
wherein if the detection rate of the wobbled shape that has been subjected to the frequency modulation or the phase modulation is lower than a predetermined threshold value, the frequency control section sets the ratio of the wobble phase error to be higher than that of the data phase error.

10. The clock signal generator of claim 2, wherein frame sync marks are arranged at regular intervals on the track of the optical disk medium, and
wherein if the detection rate of the frame sync marks is lower than a predetermined threshold value, the frequency control section sets the ratio of the data phase error to be higher than that of the wobble phase error.

11. The clock signal generator of claim 2, wherein frame sync marks are arranged at regular intervals on the track of the optical disk medium, and
wherein if the interval at which the frame sync marks are detected is longer or shorter than the predetermined interval, the frequency control section sets the ratio of the data phase error to be higher than that of the wobble phase error.

12. The clock signal generator of claim 1, wherein the frequency control section generates the frequency control signal based on the sum of the wobble and data phase errors, and
wherein the frequency control section changes the ratios of the wobble and data phase errors being added together according to a mode of operation of an optical disk drive including the clock signal generator.

13. The clock signal generator of claim 12, wherein in writing data on the optical disk medium, the frequency control section sets the ratio of the data phase error to be lower than that of the wobble phase error.

14. The clock signal generator of claim 12, wherein the clock oscillation section responds to the wobble and data phase errors more quickly in reading data from the optical disk medium than in writing data on the optical disk medium.

15. The clock signal generator of claim 12, wherein in performing linking writing such that data to be written is synchronized with data that has already been written on the optical disk medium, the frequency control section sets the ratio of the data phase error to be higher than that of the wobble phase error until the data starts to be written but sets the ratio of the data phase error to be lower than that of the wobble phase error once the data has started to be written.

16. The clock signal generator of claim 12, wherein the track has a data area to write data on and a header area with address information associated with the data area, and
wherein in reading the address information and the data from the header area and from the data area, respectively, the frequency control section sets the ratio of the wobble phase error to be lower than that of the data phase error, but
in writing the data on the data area, the frequency control section sets the ratio of the data phase error to be lower than that of the wobble phase error.

17. The clock signal generator of claim 16, further comprising a control section for detecting the frequency of the clock signal when accessing the header area, estimating, based on the frequency detected, the length of the data area that follows the header area, and locating the next header area.

18. The clock signal generator of claim 1, wherein the data phase error detecting section includes:
a sampling section for sampling the data signal in response to the clock signal and outputting a digital data signal corresponding to the data signal;
an interpolation filter section for interpolating the digital data signal, thereby outputting an interpolated digital signal;
a digital data phase error detecting section for detecting the data phase error based on the interpolated digital signal; and
a phase-locking control section for controlling a filter coefficient of the interpolation filter section based on the data phase error.

19. The clock signal generator of claim 1, wherein the wobble phase error detecting section includes:
a first frequency divider section for dividing the frequency of the clock signal by M (where M is an integer that is equal to or greater than one), thereby outputting a first frequency-divided clock signal;
a first sampling section for sampling the wobble signal in response to the first frequency-divided clock signal, thereby outputting a digital wobble signal corresponding to the wobble signal; and
a digital wobble phase error detecting section for detecting the wobble phase error based on the digital wobble signal, and
wherein the data phase error detecting section includes:
a second frequency divider section for dividing the frequency of the clock signal by N (where N is an integer that is equal to or greater than one), thereby outputting a second frequency-divided clock signal;
a second sampling section for sampling the data signal in response to the second frequency-divided clock signal, thereby outputting a digital data signal corresponding to the data signal; and
a digital data phase error detecting section for detecting the data phase error based on the digital data signal.

20. An optical disk drive comprising:
the clock signal generator of claim 1;
an optical head section for outputting a signal representing light that has been reflected from the optical disk medium; and
an analog signal processing section for extracting the wobble signal and the data signal from the output signal of the optical head section and passing the wobble and data signals to the clock signal generator.

21. A method for generating a clock signal, the method comprising the steps of:
detecting a wobble phase error that is a difference in phase between a wobble signal, which is obtained from a wobbled shape of a track on an optical disk medium, and the clock signal;
detecting a data phase error that is a difference in phase between a data signal, which is obtained from data that has been written on the optical disk medium, and the clock signal;
generating a frequency control signal to control the frequency of the clock signal based on the wobble phase error and the data phase error; and
generating the clock signal with its frequency controlled in accordance with the frequency control signal.

22. The method of claim 21, further comprising the steps of:
outputting a signal representing light that has been reflected from the optical disk medium; and
extracting the wobble signal and the data signal from the signal representing the reflected light.

23. A program for getting clock signal generation processing performed by a computer,
the clock signal generation processing including the steps of:
detecting a wobble phase error that is a difference in phase between a wobble signal, which is obtained from a wobbled shape of a track on an optical disk medium, and a clock signal;
detecting a data phase error that is a difference in phase between a data signal, which is obtained from data that has been written on the optical disk medium, and the clock signal;
generating a frequency control signal to control the frequency of the clock signal based on the wobble phase error and the data phase error; and
generating the clock signal with its frequency controlled in accordance with the frequency control signal.
